(19) United States
(12) Patent Application Publication
(10) Pub. No.: US 2023/0092425 A1
(43) Pub. Date: Mar. 23, 2023

(54) METHOD FOR PREPARING HIGH-QUALITY FUEL OIL AND/OR CHEMICAL RAW MATERIAL FROM BIOMASS PYROLYSIS LIQUID

(71) Applicants: HENAN BUF BIOENERGY CO., LTD., Zhengzhou (CN); SINOPEC LUOYANG ENGINEERING CO., LTD., Luoyang (CN); SHANGHAI HUACHANG ENVIRONMENTAL PROTECTION CO.,LTD, Shanghai (CN)

(72) Inventors: Liquan LI, Luoyang, Henan (CN); Hualin WANG, Shanghai (CN); Yuanping YUAN, Zhengzhou, Henan (CN); Chonggang CHEN, Luoyang, Henan (CN); Jianping LI, Shanghai (CN); Ying ZHAO, Luoyang, Henan (CN); Xuejing YANG, Shanghai (CN); Junjie LI, Zhengzhou, Henan (CN); Junrui CHAO, Luoyang, Henan (CN); Xuhui ZHENG, Zhengzhou, Henan (CN)

(21) Appl. No.: 17/606,481

(22) PCT Filed: Apr. 8, 2020
(86) PCT No.: PCT/CN2020/083642

§ 371 Date: Jun. 21, 2022

(30) Foreign Application Priority Data
Apr. 26, 2019 (CN) 201910342588.1

(51) Int. Cl. C10G 3/00; C10G 47/30; C10L 1/04

(52) U.S. Cl. CPC C10G 3/52; C10G 47/30; C10L 1/04; C10G 2300/1011; C10G 2300/4006; C10G 2300/4012; C10G 2300/202; C10G 2300/308; C10G 2300/302; C10G 2300/301; C10L 2200/0469

(57) ABSTRACT

A method for preparing a high-quality fuel oil and/or chemical raw material from a biomass pyrolysis liquid. In the method, a biomass pyrolysis liquid undergoes a hydrodeoxygenation reaction in a catalyst full mixing flow circulation system in a fluidized bed reactor to obtain deoxygenated oil, and the obtained deoxygenated oil undergoes a hydrocracking reaction in a fixed bed reactor to obtain high-quality fuel oil and/or a chemical raw material. The method may prevent the condensation and coking of a biomass pyrolysis liquid, solve the problem of rapid catalyst deactivation, and may convert a biomass pyrolysis liquid into a high-quality fuel oil that may be directly used by vehicles and into a chemical product.

### TECHNICAL FIELD

The present disclosure relates to the field of renewable energy sources and biomass energy sources, in particular to a method for preparing a high-quality fuel oil and/or chemical raw material from a biomass pyrolysis liquid.

### BACKGROUND ART

Energy sources are the essential matter for human survival and one of the signs of social development. The increasing demand for energy in social development, the fossil energy crisis caused by the extensive use of fossil energy, and the increasingly severe environmental problems have forced mankind to adjust the existing energy structure. It is quite necessary to find a raw material and convert it into fuel and chemical raw materials to replace existing fossil energy, especially liquid fossil energy.

Biomass (in its broad sense) refers to various organisms produced by photosynthesis with the use of atmosphere, water, soil, etc. Biomass absorbs water and carbon dioxide during growth, and converts solar energy into biomass energy which is stored. Biomass is a renewable and sustainable primary energy source. It has a huge potential but has not been fully exploited or utilized. Moreover, biomass is the only renewable energy source that can be used as a liquid fuel. Reasonable use of biomass gifted by nature in such a way that a carbon balance is maintained during production, consumption, and reprocessing will help improve the atmospheric environment, achieve energy conservation and emission reduction, and adjust the energy structure.

Biomass is converted into a liquid energy source mainly in the following ways: (i) thermochemical conversion technology, such as gasification synthesis, dry distillation, pyrolysis liquefaction (including catalyst-containing and catalyst-free processes), hydroliquefaction, etc.; (ii) bio-conversion technology, such as preparation of various alcohols (methanol, ethanol, butanol, etc.) by a fermentation process; and (iii) chemical conversion technology, such as preparation of polyols (which can be further used to prepare hydrocarbon fuels) by hydrolysis, preparation of biodiesel by esterification of oils and fats with methanol, etc.

Biomass pyrolysis liquefaction technology has the characteristics of fast reaction, high yield, simple operation, low investment and the like, and has been developed rapidly and industrialized. Up to now, an apparatus with a maximum production capacity of 50,000 ton liquid products per year has been set up in Canada. Biomass pyrolysis liquefaction technology may be classified into slow pyrolysis, fast pyrolysis, and flash pyrolysis based on heating speed and residence time; or rotating cone pyrolysis, fixed bed pyrolysis, moving bed pyrolysis, fluidized bed pyrolysis, gravity fall pyrolysis, vacuum pyrolysis and the like based on the type of pyrolysis equipment. In addition, certain liquid products are also co-produced in the carbonization and gasification of biomass. The liquid products obtained by the above methods are collectively referred to as biomass pyrolysis liquid. However, the liquid products obtained from biomass pyrolysis (hereinafter abbreviated as biomass pyrolysis liquid) cannot be supplied to transportation equipment directly or used as chemical raw materials directly. Further transformation and treatment are necessary to prepare high-quality fuels (a mixture of gasoline, diesel and aviation fuel) and chemical raw materials which can replace similar petroleum products.

The nature of biomass pyrolysis liquid is very different from that of petroleum and petroleum products. There is detailed description in many literatures (e.g. A V Bridgewater, H Hofbauer and S Van Loo, Thermal biomass conversion, CPL Press, 2009, 37-78). The characteristics of biomass pyrolysis liquid may be summarized as follows: it has a high oxygen content (oxygen content: 30-55%), a high water content and a certain amount of solid powder; it contains organic substances such as alcohols, ethers, acids, aldehydes, ketones, lipids and phenols; and it's highly polar, not miscible with petroleum (including petroleum products). Due to the presence of high moisture and a large quantity of substances containing phenolic, hydroxyl, carboxyl, carbonyl, aldehyde and other functional groups that are prone to condensation reactions, rapid catalyst deactivation and high propensity to coking are observed in the processing and treatment of biomass pyrolysis liquid. Such phenomena have brought technical difficulties and higher costs to deep processing of biomass pyrolysis liquid to prepare high value-added fuel oils and chemical products. Venderbosch, et al., Stabilization of biomass-derived pyrolysis oils, J. Chem. Technol. Biotechnol. 2010, 85: 674-686 concludes that “in hydroprocessing of bio-oils, a pathway is followed by which pyrolysis oils are further polymerized if H₂ and/or catalyst is absent, eventually to char components”. At the same time, charcoal in biomass pyrolysis liquid brings difficulties to deep processing for preparation of fuel oils. In addition, due to the high viscosity of biomass pyrolysis liquid (20-100CP at ambient temperature), it is difficult to remove by traditional filtration methods. A Javaid, et al., Removal of char particles from fast pyrolysis bio-oil by microfiltration “Journal of Membrane Science” 2010, 363(1):120-127 have analyzed and explained this aspect. Therefore, it is necessary to develop an economical method with engineering adaptability for preparing a high-quality fuel oil and a chemical product from a biomass pyrolysis liquid.

According to Chinese Patent Application CN201210153017.1, biomass pyrolysis oil is first fractionated. The resulting light components are subjected to preliminary hydrogenation and deep hydrogenation to reduce carbon deposition during reforming or catalytic condensation. The resulting heavy components are subjected to catalytic cracking treatment under the action of a noble metal rhodium-rhenium catalyst to prepare a solution rich in phenolic compounds. This method requires pretreatment to obtain different components and transforms them separately, thereby increasing the process complexity, investment cost and operating cost. Moreover, the use of a noble metal catalyst increases the difficulty and cost of catalyst recovery. Similarly, Patent Applications US20080053870A1, U.S. Ser. No. 00/595,9167A, and U.S. Pat. No. 7,578,927 separate biomass pyrolysis oil into water-soluble substances and water insoluble substances, wherein the water insoluble substances are used as reactants. The final yield is also very low.

According to Chinese Patent Application CN201210413417.1, pyrolysis oil is hydrodeoxygenated directly to obtain partially deoxygenated pyrolysis oil which is mixed with a preheated hydrocarbon product derived from petroleum. The mixture is atomized into a riser-type catalytic cracking reactor wherein one or more cracked products are prepared. Despite direct hydrodeoxygenation of pyrolysis oil, this method still cannot avoid the coking problem of pyrolysis oil during heating. At the same time, the solid powder contained in the pyrolysis oil itself (as specifically mentioned in Chinese Patent Application CN 201380024393.3) and the coke powder produced in the hydrodeoxygenation process will cause serious wear to the atomizer in the subsequent process. Meanwhile, the atomization consumes a lot of energy. In addition, oxygen cannot be removed completely from the atomized material by catalytic cracking, and the resulting product cannot be used directly as a fuel for transportation. In the process of catalytic cracking, oxygen is mainly removed by dehydration in condensation reaction. Because of the low ratio of hydrogen to oxygen and carbon in the pyrolysis liquid, the amount of coke powder produced is high, which greatly reduces the yield of the product. According to Patent Application CN 20128002116.3 and Patent Application CN201410488593.0, pyrolysis oil is hydrogenated directly. Due to the absence of any auxiliary substance for dilution and alleviation of coking, the catalyst is deactivated rapidly. On this basis, in Patent Application US20090113787A1, a noble metal palladium (Pd) having a high conversion activity is further used as a catalyst, but the catalyst still loses its activity rapidly due to occurrence of polymerization reaction.

According to Chinese Patent Application CN 201180023021.X, biomass pyrolysis oil is converted into a more stable product by hydroprocessing, and this product is mixed with gas oil, heavy fuel oil, or residual oil with a high sulfur content. The mixture is used as a fuel in a relatively demanding environment. This method only partially deoxygenates the biomass pyrolysis oil. The partial deoxygenation achieves the purpose of mixing the product with traditional fuel oil, but high-quality fuel for vehicles cannot be produced.

According to Chinese Patent Application CN201510007926.8, in order to address the coking challenge of biomass pyrolysis oil, the biomass pyrolysis oil is coked, and the liquid oil obtained by the coking is then hydrogenated. According to Patent Application CN201210413417.1, partially deoxygenated oil is obtained by hydroprocessing, and then coking is performed. Both of these methods desire to overcome the problem of catalyst deactivation by coking. However, because the polymerization reaction of biomass pyrolysis oil is very serious during the coking process, a large amount of coke powder is formed, and the final oil yield is very low.

Patent Application U.S. Pat. No. 4,795,841 proposes a two-step method for hydroprocessing biomass pyrolysis liquid, wherein the biomass pyrolysis liquid is pretreated by catalytic hydrogenation at a low temperature to obtain a relatively stable oil product, and then the oil product is further hydroprocessed. However, this method affords a low deoxygenation capacity at a low temperature, and the catalyst is deactivated rapidly. The reaction rate is slow at the relatively low temperature required in the pretreatment stage, and the space-time velocity in the reaction is very low. In addition, hydrogen consumption is high.

Patent Application US20090294324 converts biomass pyrolysis oil into liquid fuel by a two-stage hydrogenation method, and the heavy components in the final hydrocarbon product are recycled back to the first-stage reaction. Similarly, according to Patent Application CN201510224150.5, biomass hydrolysis oil and vacuum gas oil are mixed for hydroprocessing. However, these methods have not solved the problem of miscibility between pyrolysis liquid and hydrocarbons. Even if hydrolysis oil is first separated into an aqueous phase and a lignin phase which is then combined for feeding according to an optional preferred embodiment disclosed by Patent Application CN200980120914.9 (WO2009/126508), the problem of low reaction rate and short catalyst life has not been solved.

According to Patent Application US20110119994, biomass pyrolysis oil is hydroprocessed to form partially deoxygenated oil which is further mixed with mineral petroleum to be hydroprocessed. No measure is taken to alleviate polymerization and coking of biopyrolysis oil in the first step of hydroprocessing. The phenomenon of phase separation occurs to the resulting partially deoxygenated oil, including an upper layer, a middle layer and a lower layer. Particles such as coke powder are observed in the deoxygenated oil in the lower layer. This not only brings difficulties to downstream processing, but also indicates that this method has not solved the problem of polymerization coking of biopyrolysis oil or the problem of catalyst deactivation.

According to Chinese Patent Application CN201280061563.0 (WO2013/089839), hydroprocessing is performed by circulating and heating partially deoxygenated substances formed by hydroprocessing bio-oil, and then mixing them with bio-oil to be co-fed to the reactor. Although bio-oil is diluted to some extent according to this method, the hydrogen dissolving capacity of the partially deoxygenated oil is insufficient to meet the requirement of bio-oil hydrogenation, and the problem of rapid catalyst deactivation is still not solved. In addition, this method requires that the heated partially deoxygenated oil and the bio-oil, after they are mixed, contact the catalyst in the reactor and react in a short time. This imposes strict requirements on the pipelines and internal components in the reactor, and also increases the risk of coking.

According to Chinese Patent Application CN 201180054737.6 (WO2012/035410), a dispersant is used to disperse bio-oil in a hydrocarbon liquid. The dispersed mixture is hydroformed in the presence of a catalyst to generate an organic phase material which is further hydrocracked to obtain a hydrocarbon mixture. This method requires the aid of a stirrer and a pump to mix the dispersant, bio-oil and hydrocarbons to form a dispersion prior to reaction. This method increases the operation complexity. This method has not solved the coking problem after the reaction materials are preheated in an actual running process (for example, Patent Application CN201280061563.0 (WO2013/089839) describes that after the materials forming the mixed phase are heated, they should contact the catalyst in less than 60 seconds (preferably less than 10 seconds) and react). If heating is conducted after a dispersion is formed, the bio-oil will inevitably polymerize and coke in the heating furnace and the heated pipeline. This will reduce the life and operating cycle of the catalyst. According to the method disclosed by Patent Application CN201280061563.0 (WO2013/089839), pyrolysis oil is also mixed with heated hydrodeoxygenated pyrolysis oil, and then the mixture enters a reactor in a short time. It still does not solve the coking problem after the pyrolysis oil is preheated. As a result, the oxygen content of the resulting low-oxygen biomass-derived pyrolysis oil is 5-20%, which will affect the long-period operation of the second downstream hydroprocessing. Similarly, according to Patent Application CN 201380024393.3 (WO2013/135986A1), after bio-oil is mixed with an organic phase formed by hydroforming bio-oil, the mixture is subjected to hydroforming reaction, and then further to hydroprocessing to obtain hydrocarbons. However, the circulating hydroformed organic phase in this method only dilutes the bio-oil and dissolves a certain amount of hydrogen. The hydrodeoxygenation effect is very low, and the oxygen content and moisture content in the resulting hydroformed organic phase are relatively high. It is difficult to separate the organic phase and the aqueous phase in the hydroformed effluent by means of density difference. Especially, when the organic phase additionally contains a large amount of substances comprising oxygen-containing functional groups, the organic phase substances with high moisture and high oxygen content accelerate deactivation of the hydrocracking catalyst in the next step.

According to the traditional hydroprocessing methods, the polymerization reaction of biomass pyrolysis liquid is much faster than its hydroprocessing reaction, and finally, it polymerizes to form coke which leads to blockage of pipelines and equipment as well as catalyst deactivation. Although many schemes for treatment of biomass pyrolysis liquid have been proposed, there is still not an effective hydroprocessing method that has overcome the rapid catalyst deactivation problem and coking problem caused by rapid thermal polymerization of biomass pyrolysis liquid, in such a manner that the hydrodeoxygenation rate is much higher than the polymerization rate.

### SUMMARY

In order to solve the rapid catalyst deactivation problem and coking problem caused by rapid thermal polymerization of biomass pyrolysis liquid in the prior art, the present disclosure provides a method for preparing a high-quality fuel oil and/or chemical raw material from a biomass pyrolysis liquid. This method can effectively solve the problems existing in the prior art processes for treating a biomass pyrolysis liquid, and convert the biomass pyrolysis liquid into a high-quality fuel oil and chemical raw material by hydrogenation.

According to the present disclosure, there is provided a method for preparing a high-quality fuel oil and/or chemical raw material from a biomass pyrolysis liquid, comprising the following steps:

A) subjecting the biomass pyrolysis liquid to hydrodeoxygenation reaction in a completely mixed flow catalyst circulation system in a fluidized bed reactor to obtain a deoxygenated oil;

B) subjecting the deoxygenated oil from step A) to hydrocracking reaction in a fixed bed reactor to obtain a high-quality fuel oil and/or chemical raw material.

The completely mixed flow catalyst circulation means that the macroscopic movement of the catalyst particles is manifested as a movement in the form of fluidization from the bottom of the reactor to the material level in the reactor, and then back to the bottom of the reactor. The catalyst is a spherical catalyst.

The completely mixed flow catalyst circulation system is formed under the combined action of the biomass pyrolysis liquid, a hydrogen donor, a circulating oil, hydrogen, a catalyst, a hydrodeoxygenation product and an internal component. Specifically, the completely mixed flow catalyst circulation system is formed under the combined action of the following three factors: the fluidization kinetic energy provided by the circulating oil and hydrogen drives the catalyst into a fluidized state; the high-speed disturbance of the fluidized catalyst and a mixture of the circulating oil and hydrogen promotes rapid mixing and dilution of the biomass pyrolysis liquid and the hydrogen donor; and the internal component of the fluidized bed reactor acts to direct, split and swirl a gas-liquid-solid three-phase mixture.

The biomass pyrolysis liquid is mixed with the hydrogen donor before entering the fluidized bed reactor, and then enters the reactor at room temperature to 80° C., preferably at room temperature to 50° C., under the protection of the hydrogen donor. The biomass pyrolysis liquid includes a liquid substance derived from various biomass species by slow pyrolysis, fast pyrolysis, flash pyrolysis, carbonization or gasification processes.

The hydrogen donor is at least one of hydrocarbon substances obtained by hydrocracking, petroleum hydrocarbon substances, hydrocarbon substances obtained by hydroprocessing coal tar, and hydrocarbon substances obtained by hydrodeoxygenation of organics. The boiling point of the hydrocarbon substances is in the range of 160-260° C.

The catalyst is a Group VIII metal alone or a Group VIII metal with one or two of the Group IVB, Group VB, Group VIB, Group VIIB, Group IB, and Group IIB metals added as an active component supported on activated carbon or porous carbon, or a catalyst formed from a metal oxide with a carbonized surface.

After the catalyst is discharged from the bottom of the fluidized bed reactor, it is regenerated by washing with an alcohol, hydrocarbon or tetrahydrofuran solvent to restore activity.

The hydrodeoxygenation reaction employs a temperature of 200° C.-400° C., a pressure of 10-20 MPa, a reaction volume space velocity of 0.6-2.0 h⁻¹, a hydrogen-to-oil ratio of 400:1-1000:1, a circulation ratio of 1:4-4:1, a mass ratio of the hydrogen donor to the biomass pyrolysis liquid of 0.2:1-4:1; and the hydrocracking reaction employs a temperature of 150° C.-420° C., a pressure of 12-20 MPa, a reaction volume space velocity of 1.0-4.0 h⁻¹, and a hydrogen-to-oil ratio of 400:1-1200:1.

It should be noted that the hydrogen-to-oil ratio mentioned herein refers to a volume ratio, and the circulation ratio refers to a mass ratio.

The deoxygenated oil may be directly subjected to hydrocracking treatment, or it may be blended with at least one of heavy diesel, wax oil and coal tar, and then enter a fixed bed reactor for hydrocracking treatment. In both cases, after the hydrocracking treatment, a high-quality fuel oil and/or chemical raw material is obtained.

The fluidized bed reactor may adopt a single-stage form, or a form of two stages or multiple stages in series. The fixed-bed reactor may adopt a single-stage form, or a form of two stages or multiple stages in series. The fluidized-bed reactor may be called a hydrodeoxygenation reactor; and the fixed bed reactor may be called a hydrocracking reactor or a hydrofining reactor.

In the present disclosure, an un-pretreated all-component biomass pyrolysis liquid is added directly to a reaction zone of the hydrodeoxygenation fluidized bed reactor under the protection of the hydrogen donor. The biomass pyrolysis liquid undergoes the hydrodeoxygenation reaction in the fluidized bed reactor in the completely mixed flow catalyst circulation system formed under the combined action of the thermal circulating oil, the hydrogen donor, the catalyst, the hydrogen and the internal component. The effluent of the hydrodeoxygenation reaction is separated to obtain a deoxygenated oil and an aqueous phase substance. The deoxygenated oil (having a moisture content of less than 0.1%) is divided into two portions. One portion of the deoxygenated oil, used as a circulating oil, is mixed with hydrogen and then heated to a temperature of higher than 250° C. Then, the mixture returns to the fluidized bed reactor from the bottom of the reactor, and enters the hydrodeoxygenation reaction bed layer after passing through the distributor. The other portion of the deoxygenated oil is mixed with hydrogen, and enters the hydrocracking reactor (a fixed bed reactor) for hydrocracking reaction. The effluent of the hydrocracking reaction is separated to obtain an oil substance and an aqueous phase substance. The oil substance enters a fractionation tower where it is fractionated to obtain high-quality fuel oil and chemical products.

The biomass pyrolysis liquid used in the present disclosure needs no pretreatment. Even if the biomass pyrolysis liquid contains a minute amount of particulate matter, it will be removed through a discharge system for the catalyst. Before contacting the catalyst, the biomass pyrolysis liquid is maintained at room temperature to prevent polymerization of the biomass pyrolysis liquid.

The reason why biomass pyrolysis liquid is prone to polymerization reaction and coking is that its components are rich in aldehydes, ketones, ethers, phenols and the like. The polymerization reaction rate of these substances gets faster as the temperature rises. In addition, in the pyrolysis process of biomass, carbohydrates produced by cracking of cellulose and hemicellulose will also undergo dehydration reaction to obtain macromolecular polymers after heated, and even further undergo dehydration to obtain coke. These polymers and coke will cause deactivation of the catalyst.

In the present disclosure, the biomass pyrolysis liquid is added directly to the reaction bed zone to undergo reaction, and at the same time, the biomass pyrolysis liquid is prevented from being heated in the pipeline by entrapping and wrapping the biomass pyrolysis liquid with the hydrogen donor, so as to ensure that the temperature of the biomass pyrolysis liquid is less than 80° C., preferably less than 50° C. before it enters the reaction bed.

The hydrogen donor is selected from the middle distillate in the high-quality fuel oil obtained according to the present disclosure, or petroleum hydrocarbon products, hydrocarbon substances obtained by hydroprocessing coal tar, and other hydrocarbon substances obtained by hydrodeoxygenation of organics. The boiling point of the hydrocarbon substances is preferably in the range of 160-260° C. Since the biomass pyrolysis liquid is a polar substance, the solubility of hydrogen in the hydrogen donor is hundreds of times higher than that in the biomass pyrolysis liquid under the same conditions. The addition of the hydrogen donor also enhances the hydrogen dissolving capacity of the materials in the reactor greatly, thereby accelerating the deoxygenation reaction of the biomass pyrolysis liquid and reducing the polymerization reaction rate. At the same time, the hydrogen donor also acts as a protective agent to prevent the biomass pyrolysis liquid from being overheated.

The deoxygenated oil and hydrogen (including circulating hydrogen and the hydrogen-rich gas separated from the hydrocracking reactor) are heated by a heating furnace, distributed by the distributor at the bottom of the fluidized bed reactor, and then enter the reactor to provide a heat source for the hydrodeoxygenation reaction and kinetic energy for fluidization of the catalyst. In addition, the temperature of the hydrodeoxygenation reaction is controlled by controlling the temperature of the mixture of the deoxygenated oil and hydrogen. The deoxygenated oil is a thermally stable oil phase component obtained by hydroconversion of the components in the biomass pyrolysis liquid that are prone to polymerization. In the presence of hydrogen, the deoxygenated oil is not prone to polymerization reaction when it is heated to 450° C. or even a higher temperature. In addition, the mixture of the deoxygenated oil and hydrogen provides kinetic energy for fluidization of the fluidized bed catalyst, and the fluidization state of the catalyst is controlled by controlling the flow rate of the deoxygenated oil. In addition, the high-speed disturbance of the fluidized catalyst and the mixture of the deoxygenated oil and hydrogen heats, blends and dilutes the biomass pyrolysis liquid and the hydrogen donor, and the biomass pyrolysis liquid is hydrodeoxygenated step by step as its temperature rises, so as to further prevent occurrence of polymerization reaction.

The spherical catalyst used in the present disclosure is in a completely mixed circulation state in the reaction bed zone. This is beneficial to the mass and heat transfer in the deoxygenation reaction, and helps to avoid the phenomenon of polymerization and coking caused by excessively high local temperature in the strongly exothermic hydrodeoxygenation reaction. The completely mixed flow catalyst circulation means that the macroscopic movement of the catalyst particles is manifested as fluidization from the bottom of the reactor to the material level in the reactor, and then back to the bottom of the reactor. The spherical catalyst has a structure comprising a dense outer shell layer and a highly porous inner skeleton, and has the characteristics of high strength and high wear resistance, thereby ensuring that the catalyst will not be broken and the skeleton will not collapse even in the fluidized state. When the catalyst is in the state of completely mixed flow circulation, particularly when a special three-phase separator that enables high-speed rotation of the materials is used additionally, the rotation and friction of the catalyst particles have a self-cleaning effect on the polymer on the outer surface of the catalyst, which further prevents polymer aggregation that will cause deactivation of the catalyst.

The biomass pyrolysis liquid added directly and the hydrogen donor are rapidly diluted and mixed with hydrogen and the deoxygenated oil in the completely mixed flow circulation state system. The oil-water mixture flowing out of the fluidized bed reactor looks like an emulsion, and a large quantity of slowly-disappearing foam appears at the oil-water interface, indicating that the substances comprising oxygen-containing functional groups in the deoxygenated oil have the properties of surfactants. In the completely mixed flow circulation system, these substances comprising oxygen-containing functional groups can allow the polar biomass pyrolysis liquid, non-polar hydrogen donor and weakly polar deoxygenated oil to form a homogeneous phase, which promotes rapid reaction between the free hydrogen carried by the hydrogen donor and the free hydrogen formed from hydrogen with the biomass pyrolysis liquid to prevent polymerization reaction, and prevent rapid deactivation of the catalyst.

The product from the fluidized bed reactor enters a cold high-pressure separator for gas-liquid separation. A portion of the separated gas is used as circulating hydrogen for the hydrodeoxygenation reaction in the fluidized bed, and the other portion of the gas is discharged as waste hydrogen which passes through a hydrogen purification apparatus and returns to a fresh hydrogen pipeline. The ratio of the circulating hydrogen to the discharged waste hydrogen is adjusted to adjust the partial pressure of hydrogen in the hydrodeoxygenation reaction in the fluidized bed. The separated liquid is further separated with an oil-water separation apparatus to form a deoxygenated oil and an aqueous phase substance. The aqueous phase substance enters a downstream water treatment facility. A portion of the deoxygenated oil returns to the fluidized bed reactor as a circulating oil, and the other portion enters a next stage hydrocracking reactor. Since the substances comprising oxygen-containing functional groups in the deoxygenated oil are surfactants, along with the release of a large quantity of gas in the process from high pressure to low pressure, the oil-water mixture is emulsified, together with generation of a large quantity of foam. It's difficult to separate the emulsified oil-water mixture under static conditions by means of density difference. At the same time, a separation apparatus meeting the process requirements will also have a huge volume. Nonetheless, as the oxygen content of the deoxidized oil (the oxygen content in the present disclosure is controlled at 5%-15%) is reduced greatly, the polarity of the deoxidized oil is reduced greatly to nearly non-polar (<10 μs/cm), especially with the addition of the hydrogen donor. The aqueous phase obtained at the same time has strong polarity due to the dissolved carboxylic acids and alcohols. The present disclosure makes use of the polarity difference of these two phases to realize separation thereof.

It's also mentioned by Williams P T and Nugranad N. in “Comparison of products from the pyrolysis and catalytic pyrolysis of rice husks” [J], Energy, 2000, 25(6):493-513 that oxygen is removed mainly in the form of CO and CO₂ at high temperatures, and mainly in the form of H₂O at low temperatures. The lower the hydrodeoxygenation reaction temperature, the lower the reaction rate, while the water yield is increased, and the consumption of hydrogen is increased. The higher the hydrodeoxygenation reaction temperature, the higher the polymerization reaction rate of the biomass pyrolysis liquid, leading to an increased risk of coking. In order to prevent catalyst deactivation caused by polymerization and coking of the biomass pyrolysis liquid, when a single high-performance catalyst is used, the fluidized bed hydrodeoxygenation reactor may be a single-stage reactor, because the high-performance catalyst (such as ruthenium, palladium, etc.) can reduce the activation energy of the hydrogenation reaction, and promote the hydrodeoxygenation reaction to achieve the required deoxygenation target at a relatively low temperature. In the case where catalysts of different performances are used, and/or where the same catalyst is used but different operation temperatures are required, the fluidized bed hydrodeoxygenation reactor may include two-stage or multi-stage reactors in series. The main purpose is to treat the substances that are prone to polymerization reaction separately.

The deoxygenated oil is close to a non-polar fuel oil. They are miscible in any ratio without stratification. The sulfur and nitrogen contents in the deoxygenated oil are very low, and a certain oxygen content (usually <10%, preferably <8%) is conducive to complete combustion, so the deoxygenated oil can be used as a low-sulfur, low-nitrogen fuel oil, especially in high-altitude areas. The emission of particulate matter, sulfides and nitrogen oxides from combustion is lower than the emission produced by traditional fossil fuel oils.

However, because the economic value of the deoxygenated oil used as a fuel oil is far lower than that of high-quality fuel oils (gasoline, diesel and aviation fuel) and chemical raw materials obtained by deep processing, the deoxygenated oil and hydrogen are heated to undergo fixed-bed hydrocracking reaction. The gas separated from the effluent of the hydrocracking reaction by a gas-liquid separator is mixed with the circulating hydrogen, and then mixed with the circulating oil and heated before entering the fluidized bed hydrodeoxygenation reactor. The liquid separated from the effluent of the hydrocracking reaction by the gas-liquid separator is further separated by an oil-water separation apparatus to form an oil substance and an aqueous phase substance, wherein the aqueous phase substance enters a water treatment facility, and the oil substance enters a fractionation tower. The oil-water separation principle is also mainly based on the polar difference between the oil substance and the aqueous phase substance to achieve separation.

Because the deoxygenated oil is a relatively stable substance, from the perspective of reducing investment and operating costs, it is preferred to choose a fixed bed for the hydrocracking reactor. However, the deoxygenated oil still contains a small amount of olefins that are prone to polymerization. In order to guarantee long-term operation of the equipment, in the case where a single composite catalyst is used, the hydrocracking reactor may be selected as a single stage reactor; in the case where catalysts of different performances are used and/or different reaction temperatures are required, two-stage or multi-stage reactors in series may be used to perform hydrocracking and/or hydrofining reactions on the deoxygenated oil.

After the hydrocracking reaction, the oil substance is heated and then enters the fractionation tower to be separated into a light hydrocarbon fraction at the top, a naphtha fraction at the upper part, a hydrogen donor fraction at the middle part, a diesel fraction at the lower part, and a heavy diesel fraction at the bottom of the tower. A fraction having a boiling range of 120-300° C. (preferably 160-260° C.) is chosen as the hydrogen donor. The fraction having a lower boiling point is not recommended to be used as the hydrogen donor, because the naphtha fraction of a lower boiling point can be vaporized more easily after being recycled to the hydrodeoxygenation reactor, thereby reducing the partial pressure of hydrogen in the reactor.

In addition, the final boiling point of the hydrocracked oil substance obtained according to the present disclosure is less than 420° C. The high boiling point substance may be used directly as heavy diesel. In order to increase the output of the high-quality fuel oil and chemical raw material, the oil substance of the higher boiling point fraction may also be mixed with the hydrogen donor and then recycled back to the hydrodeoxygenation reactor.

The method according to the present disclosure has the following beneficial effects:

1) The biomass pyrolysis liquid is converted into chemical products, and high-quality fuels that can be used by vehicles directly.

2) The operating cost is low because of low hydrogen consumption, the ability to use non-precious metal catalysts, and mild operating conditions.

3) Condensation and coking of the biomass pyrolysis liquid under heating are prevented.

4) The problem of rapid catalyst deactivation is solved, and the formation of coke is prevented, thereby meeting the requirements of industrial long-term operation.

5) The method according to the present disclosure is applicable to a wide variety of biomass pyrolysis liquid sources which can be used directly without pretreatment such as filtration, phase separation, etc.

6) In order to achieve a scale effect, the biomass pyrolysis liquid may be hydroprocessed together with heavy diesel, wax oil or coal tar (referred to as co-refining) to prepare high-quality fuel oils and/or chemical raw materials.

### DESCRIPTION OF THE DRAWINGS

FIG. 1 is a schematic view showing a process flow diagram of the method for preparing high-quality fuel oils and chemical raw materials according to the present disclosure;

FIG. 2 is a GCMS analysis chart of a biomass pyrolysis liquid;

FIG. 3 is a GCMS analysis chart of a deoxygenated oil;

FIG. 4 shows the molecular weight distribution map of a high-quality fuel oil and a dry biomass pyrolysis liquid, gasoline and diesel;

FIG. 5 is a schematic view showing a process flow diagram of a method for co-refining a biomass pyrolysis liquid with heavy diesel, wax oil and coal tar to prepare high-quality fuel oils and chemical raw materials.

### DETAILED DESCRIPTION

The present disclosure will be further illustrated with reference to the accompanying drawings and the following Examples.

### EXAMPLE 1

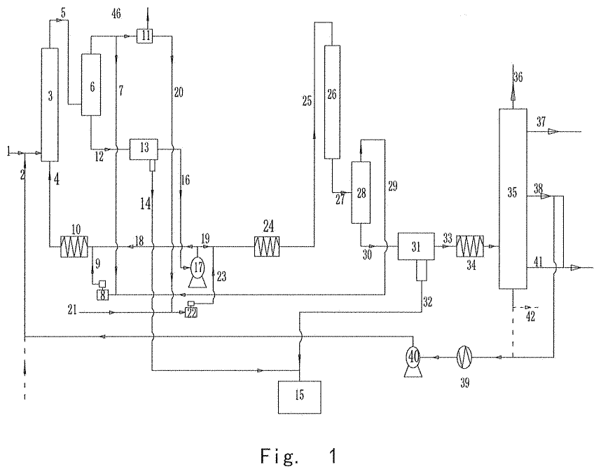

As shown by FIG. 1, a biomass pyrolysis liquid 1 entrapped and protected by a hydrogen donor 2 was fed directly to the reaction bed zone of a single-stage fluidized bed hydrodeoxygenation reactor 3 at room temperature. The mass ratio of the biomass pyrolysis liquid to the hydrogen donor was 1:0.5. The hydrogen donor was a petroleum hydrocarbon substance having a boiling point of 200-240° C. Circulating hydrogen 7 and a gaseous substance 29 from the hydrocracking reaction were pressurized by a circulating hydrogen compressor 8 to form a mixed gas 9. The mixed gas 9 was mixed with a circulating oil 18 and heated by a heating furnace 10 to form a gas-liquid mixture 4. The gas-liquid mixture 4 entered the fluidized bed hydrodeoxygenation reactor 3 from the bottom thereof and provided kinetic energy for fluidization in the hydrodeoxygenation reaction. The temperature of the hydrodeoxygenation reaction was controlled at 280° C. by adjusting the temperature of the gas-liquid mixture 4. The biomass pyrolysis liquid was heated, mixed and diluted rapidly under the high-speed disturbance of the completely mixed flow circulating catalyst and the mixture of the circulating oil and hydrogen, and underwent the hydrodeoxygenation reaction. After the reaction effluent 5 was separated by a cold high-pressure gas-liquid separator 6, a portion of the gaseous substance was recycled as circulating hydrogen 7 back to the hydrodeoxygenation reactor, and the other portion of the gaseous substance was purified by a hydrogen purification facility 11. The regenerated hydrogen 20 was combined into fresh hydrogen 21, and then entered the hydrocracking reactor. After the liquid substance 12 flowing out of the cold high pressure separator was further separated by an oil-water separator 13, the aqueous phase substance 14 entered a water treatment facility 15. The deoxygenated oil 16 was pressurized by a circulating pump 17. A portion of the pressurized deoxygenated oil returned to the hydrodeoxygenation reactor as the circulating oil 18, and the other portion of the deoxygenated oil 19 entered a hydrocracking reactor.

The fluidization state of the hydrodeoxygenation reaction catalyst was controlled by controlling the amount of the circulating oil 18, so as to meet the operating range of the fluidized bed reactor. The weight ratio of the circulating oil to the biomass pyrolysis liquid was 4:1 in this Example.

The hydrogen-to-oil ratio in the hydrodeoxygenation reaction was controlled by controlling the amount of circulating hydrogen. In this Example, the hydrogen-to-oil ratio by volume was 500:1. If the hydrogen-to-oil ratio was too low, the reaction would be incomplete, and polymerization and coking would occur. If the hydrogen-to-oil ratio was too high, the energy consumption would be increased, and at the same time, three-phase separation in the fluidized bed reactor would be rendered difficult (beyond the operating range of the fluidized bed reactor).

Compared with a strip-shaped catalyst, the high-strength and high-wear-resistance microspherical catalyst according to the present disclosure had the following advantage in a completely mixed flow circulation system: the polymerization and coking phenomenon caused by excessively high local temperature in the strongly exothermic hydrodeoxygenation reaction was avoided. The rotation and slight friction of the catalyst particles had a self-cleaning effect on the polymer on the outer surface of the catalyst, thereby preventing the polymer from further agglomerating and causing deactivation of the catalyst. Pd/C (palladium supported on a carbon-based material) was used as the hydrodeoxygenation catalyst in this Example.

The liquid hourly volume space velocity in this Example was 1.2h⁻¹, and the reaction pressure was 13.0 MPa.

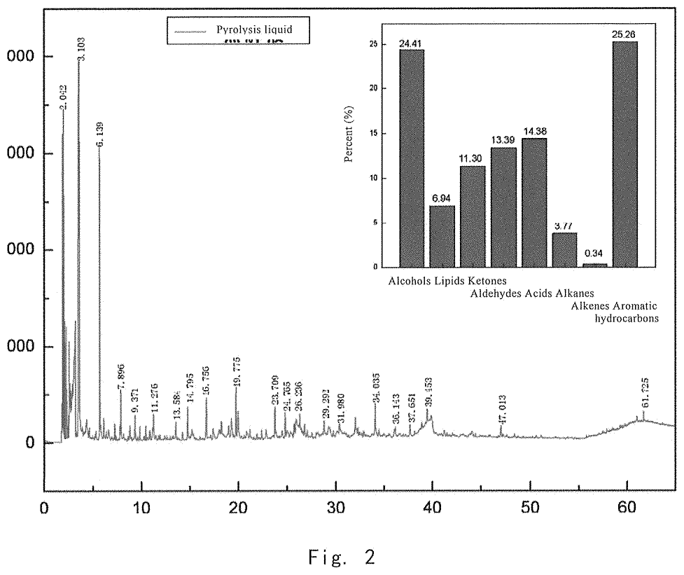

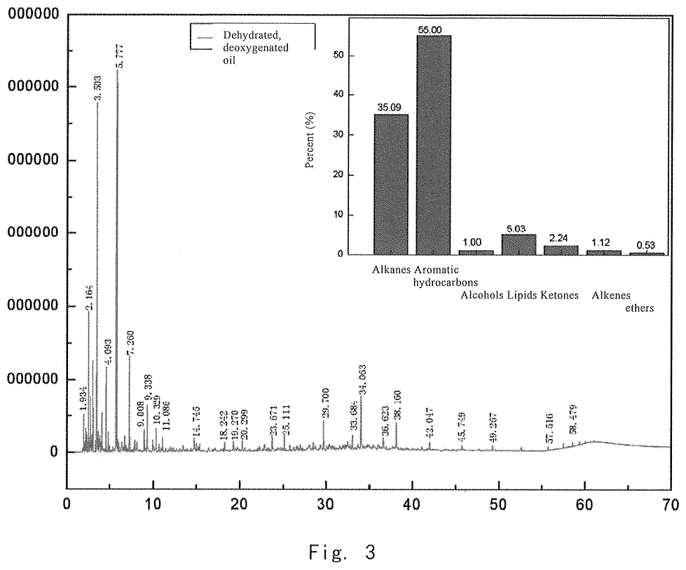

The biomass pyrolysis liquid used in this Example was a liquid product obtained by rapid pyrolysis of pine wood chips. After the hydrodeoxygenation reaction in this Example ran for 1000 hours, the material balance data are shown in Table 1, the material properties of the biomass pyrolysis liquid and the deoxygenated oil are shown in Table 2, and the composition analysis is shown in Table 3. The GCMS analysis results of the biomass pyrolysis liquid and the deoxygenated oil are shown in FIG. 2 and FIG. 3, respectively, indicating that most of the oxygen in the pyrolysis liquid was converted into water, CO, and CO₂ after hydrodeoxygenation, and thus removed. The resulting deoxygenated oil can be used as a raw material for hydrocracking. The composition of the gas generated in the hydrodeoxygenation reaction is shown in Table 4.

Material balance data of the hydrodeoxygenation reaction

| | Raw materials | | Products | | |
|---|---|---|---|---|---|
| | Pyrolysis | | Deoxygenated | Aqueous | Gas |
| | liquid | Hydrogen^{Note1} | oil | phase | phase^{Note2} |
| Weight, g | 64160 | 988 | 29653 | 29022 | 6473 |
| Total, g | 65148 | | 65148 | | |
| Consumption or | 98.48 | 1.52 | 45.52 | 44.55 | 9.93 |
| yield^{Note 3}, wt % | | | | | |

Note 1:
Hydrogen represents the amount of hydrogen consumed during thereaction. The flow rate of the gas entering the hydrodeoxygenation reactor and the flow rate of the gas exiting the hydro de oxygenation reactor as well as the hydrogen contents therein were measured and analyzed. The difference between the amount of hydrogen entering the hydrodeoxygenation reactor and the amount of hydrogen exiting the hydrodeoxygenation reactor was used as the hydrogen consumption in the hydrodeoxygenation reaction.
Note 2:
The gas phase was the gas phase substance produced in the hydrodeoxygenation reaction, excluding the amounts of hydrogen and other gas components in the circulating hydrogen.
Note 3:
The product yield was the mass percentage of each product over the total consumption (including the hydrogen consumption).

TABLE 2
Comparison of properties of the biomass pyrolysis liquid and the
deoxygenated oil produced by the hydrodeoxygenation reaction

| | | Biomass | Deoxygenated |
|---|---|---|---|
| | | pyrolysis liquid | oil |
| Density, g/cm³ | | 1.18 | 0.91 |
| Viscosity | (@20° C.) | 80 | 1.2 |
| cp | (@60° C.) | 20 | 0.93 |
| Moisture, % | | 28 | 0.0050 |
| HHV (higher | | 16.7 | 42.5 |
| heating value), MJ/kg | | | |
| TAN (acid number), | | 120 | 11 |
| mgKOH/g | | | |
| Elemental | C, wt % | 43.6 | 81.1 |
| composition | H, wt % | 6.9 | 11.4 |
| | 0, wt % | 49.4 | 7.4 |
| | Others, wt % | <0.1 | <0.1 |
| pH value | | 2.7 | / |
| Distillation | Initial boiling | 50 | 52 |
| range ° C. | point | | |
| (ASTM | 5% | 60 | 105 |
| D1160) | 20% | 102 | 137 |
| | 40% | 280 | 192 |
| | 60% | 375 | 235 |
| | 80% | 500 | 297 |
| | 95% | 650 | 381 |
| | 98% | / | 440 |
| | Final boiling | / | 495 |
| | point | | |

TABLE 3
Comparison of GCMS Note 4 analysis results of the biomass pyrolysis
liquid and the dehydrated hydrodeoxygenated oil

| | Biomass pyrolysis | Hydro- |
|---|---|---|
| | liquid (dry basis) | deoxygenated oil |
| Alcohols | 13.06 | 2.48 |
| Lipids | 7.94 | 4.73 |
| Ketones | 12.93 | 1.15 |
| Aldehydes | 15.33 | 0.00 |
| Ethers | 0.66 | 2.05 |
| Carboxylic acids | 16.46 | 0.01 |
| Phenols | 18.75 | 15.15 |
| Alkanes | 4.32 | 47.65 |
| Aromatic | 10.16 | 25.28 |
| hydrocarbons | | |
| Unsaturated | 0.39 | 1.50 |
| hydrocarbons | | |

Note 4:
GCMS analysis was performed under the condition of heating up to 350° C., excluding substances having a boiling point higher than this temperature.

TABLE 4
The composition based on volume percentage
of the gas generated by the hydrodeoxygenation
reaction (excluding hydrogen)

| | Component, V/V% |
|---|---|
| CO | 6.95 |
| CO₂ | 53.81 |
| CH₄ | 20.53 |
| C₂H₆ | 9.27 |
| C₂H₄ | 1.16 |
| C₃ | 5.96 |
| C₄ | 1.96 |
| C₅ and C₅₊ | 0.33 |

In the hydrodeoxygenation reaction, the aldehydes, sugars and some carboxylic acids that are prone to polymerization in the biomass pyrolysis liquid were converted into stable alcohols and hydrocarbons, and some alcohols, carboxylic acids and other polar substances were converted into hydrocarbons, hydrogen, water, CO and CO₂ in the reaction. Some unreacted alcohols and carboxylic acids entered the aqueous phase in the oil-water separation apparatus. The oil phase mainly included phenolic substances, hydrocarbons and other substances having stable properties. The fraction range of the deoxygenated oil was reduced greatly to a maximum boiling point of 495° C. for the reason that the macromolecular components in the biomass pyrolysis liquid were mainly linked by oxygen atoms, but oxygen was released in the form of water, CO and CO₂ during the hydrodeoxygenation process, thereby tailoring the macromolecules in the biomass pyrolysis liquid into small molecules such as hydrocarbons, alcohols, and carboxylic acids.

It was further discovered in the experiment that, relative to the mass of the biomass pyrolysis liquid, the total oxygen content was reduced from 49.4% to 7.4%. After deducting the 24.89% oxygen content in the water content of the biomass pyrolysis liquid, the amount of oxygen removed in the hydrodeoxygenation reaction accounted for 17.11%. The amount of oxygen removed in the form CO and CO₂ in the hydrodeoxygenation reaction was 5.10%, mainly because of the decarbonylation reaction and decarboxylation reaction. Some alcohols were also likely to be cracked in the presence of water vapor to generate hydrogen, but the generation of hydrogen was accompanied by the generation of CO and CO₂. So, the overall hydrogen-to-oxygen ratio would not be changed. 12.01% of the oxygen was removed in the form of water in the hydrodeoxygenation reaction. Theoretically, the mass of hydrogen required to be consumed in order to remove the oxygen was about 1.50% of the biomass pyrolysis liquid. The actual amount of hydrogen consumed was 1.54% of the mass of the biomass pyrolysis liquid, indicating that the main process in the hydrodeoxygenation reaction was deoxygenation, and only a small part of the carbon-carbon bonds were broken. In addition, judging from the composition of the gas generated during the reaction, the mass of CO and CO₂ accounted for about 70% of the generated gas, confirming again that the main process in the hydrodeoxygenation reaction was deoxygenation, and only a small amount of light hydrocarbons were produced. Moreover, a part of the light hydrocarbons were derived from deoxygenation of methyl esters and ethyl esters.

After the hydrodeoxygenation reaction in this Example ran for 2000 hours, the catalyst was removed from the fluidized bed hydrodeoxygenation reactor and fully washed with a furan solution. The weight of the catalyst after drying was compared with the weight of the catalyst added before the reaction, and there was no increase in weight. This means that little or no coke was formed.

The fresh hydrogen 21 was mixed with the regenerated hydrogen 20. After being pressurized by a hydrogen compressor 22, the resulting hydrogen 23 was mixed with the deoxygenated oil 19. After being heated by a heating furnace 24, the gas-liquid mixture 25, as a raw material, entered a single-stage fixed-bed hydrocracking reactor 26. The temperature of the hydrocracking reaction was controlled at 360° C. by adjusting the temperature of the gas-liquid mixture 25. After the reaction effluent 27 passed through a cold high pressure gas-liquid separator 28, the gas substance 29 was supplied as supplementary hydrogen to be used in the hydrodeoxygenation reaction. After the liquid substance 30 was separated by an oil-water separator 31, the aqueous phase substance 32 entered the water treatment facility 15, and the high-quality fuel oil 33 produced was heated by a heating furnace 34 and then entered a fractionation tower 35. The light hydrocarbon fraction 36 was discharged from the top of the fractionation tower; the naphtha fraction 37 was extracted from the upper part of the fractionation tower; and the fraction 38 having a boiling range of 200-240° C. was extracted from the side line of the middle part of the fractionation tower. A portion of the fraction 38 was cooled by a cooler 39, pressurized by a hydrogen donor pump 40, and then recycled back to the hydrodeoxygenation reactor as the hydrogen donor 2. The other portion of the fraction 38 was discharged and combined into the light diesel 41 pipeline at the lower part of the tower. The heavy diesel fraction 42 at the bottom of the tower could be discharged for sale as a product. In order to increase the output of the naphtha fraction, gasoline and diesel, the heavy diesel fraction 41 discharged from the bottom of the tower could also be mixed with the hydrogen donor 2, and then recycled back to the hydrodeoxygenation reactor. It could pass through the two-stage reactor of hydrodeoxygenation and hydrocracking to produce distillate materials having lower boiling points.

The hydrogen-to-oil ratio in the hydrocracking reaction was controlled by controlling the flow rate of hydrogen 23 with a hydrogen compressor 22. In this Example, the hydrogen-to-oil ratio in the hydrocracking reaction was 700:1. In this Example, CoW/Al₂O₃ was used as the hydrocracking catalyst. The liquid hourly volume space velocity in this Example was 2.0 h⁻¹, and the reaction pressure was 15.0 MPa.

The pressure in the hydrocracking reaction was higher than that in the hydrodeoxygenation reaction, because higher pressure was desirable to increase the partial pressure of hydrogen in the hydrocracking reaction, thereby promoting the reaction. At the same time, after the hydrocracking reaction, the gaseous substance 29 obtained by gas-liquid separation needed to be recycled to the hydrodeoxygenation reaction, so a higher pressure was conducive to the pressure balance of the system. In addition, it was also found in this experiment that a lower hydrogen concentration could also meet the requirements of the hydrodeoxygenation reaction in the present disclosure. Compared with a method in which the gaseous substance 29 was discharged into a waste hydrogen pipeline to be regenerated with a hydrogen purification facility, and an additional hydrogen compressor was needed to increase its pressure (for pressure balance) before it was incorporated into the pipeline of the circulating hydrogen 9, in the present disclosure, the gaseous substance 29 from the hydrogen cracking reaction was incorporated into the pipeline of the circulating hydrogen 9, and the circulating hydrogen compressor 8 was shared. This method saved investment and energy consumption greatly.

The material balance data of the hydrocracking reaction in this Example are shown in Table 5; the material properties of the raw material for the hydrocracking reaction and the resulting high-quality fuel oil are shown in Table 6; and the composition analysis of the gas produced in the hydrocracking reaction is shown in Table 7.

TABLE 5
Material balance data of the hydrocracking reaction

| | Raw materials | | Products | | |
|---|---|---|---|---|---|
| | De- | | High- | | |
| | oxygenated | Hydro- | quality | | Gas |
| | oil, | gen^{Note 5}, | fuel oil, | Aqueous | phase^{Note 6}, |
| | g | g | g | phase, g | g |
| Weight | 31120 | 265 | 26881 | 2495 | 2009 |
| Total, g | 31385 | | 31385 | | |
| Con- | 99.16 | 0.84 | 85.65 | 7.95 | 6.4 |
| sumption | | | | | |
| or | | | | | |
| yield^{Note 7}, | | | | | |
| wt % | | | | | |

^{Note 5}:
Hydrogen represents the amount of hydrogen consumed during the hydrocracking reaction. The flow rate of the gas entering the hydrocracking reactor and the flow rate of the gas exiting the hydrocracking reactor as well as the hydrogen contents therein were measured and analyzed. The difference between the amount of hydrogen entering the hydrocracking reactor and the amount of hydrogen exiting the hydrocracking reactor was used as the hydrogen consumption in the hydrocracking reaction.
^{Note 6}:
The gas phase was the gas phase substance produced in the hydrocracking reaction, excluding hydrogen.
^{Note 7}:
The product yield was the percentage of each product over the total consumption (including the hydrogen consumption).

TABLE 6
Comparison of the properties of the deoxygenated oil and the fuel oil
produced by the hydrocracking reaction

| | | Deoxygenated oil | High-quality fuel oil |
|---|---|---|---|
| Density, g/cm³ | | 0.91 | 0.82 |
| HHV, MJ/kg | | 42.5 | 46.2 |
| TAN, mgKOH/g | | 11 | 0.2 |
| Elemental | C, % | 81.1 | 87.9 |
| composition | H, % | 11.4 | 12.0 |
| | O, % | 7.4 | <0.01 |
| | Others, % | <0.1 | <0.1, wherein |
| | | | S < 10 ppm |
| Distillation | Initial | 52 | 55 |
| range | boiling | | |
| ° C. | point | | |
| (ASTM | 5% | 105 | 89 |
| D1160) | 20% | 137 | 135 |
| | 40% | 192 | 168 |
| | 60% | 235 | 217 |
| | 80% | 297 | 277 |
| | 95% | 381 | 341 |
| | 98% | 440 | 375 |
| | Final | 495 | 420 |
| | boiling | | |
| | point | | |

TABLE 7
Gas phase analysis results for the hydrocracking

| | Tail gas composition, | Tail gas composition |
|---|---|---|
| | V/V % | (excluding hydrogen), V/V % |
| H₂ | 91.37 | / |
| CO | 0.21 | 2.46 |
| CO₂ | 0.20 | 2.27 |
| CH₄ | 4.85 | 56.14 |
| C₂H₆ | 1.76 | 20.41 |
| C₂H₄ | 0.00 | 0.00 |
| C₃ | 0.70 | 8.13 |
| C₄ | 0.52 | 6.05 |
| C₅ and C₅₊ | 0.39 | 4.54 |

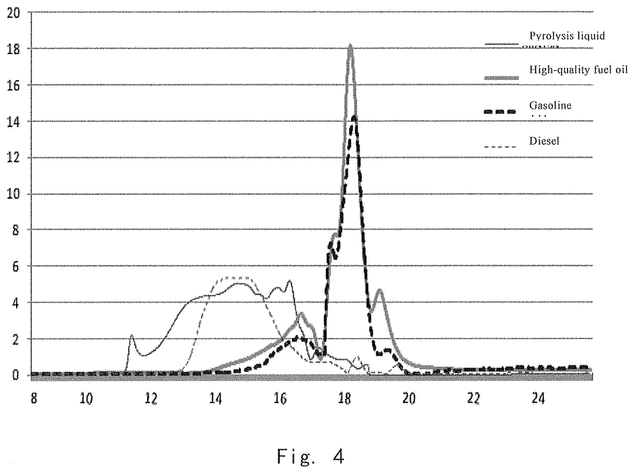

In the hydrocracking reaction, while oxygen was further removed, the macromolecular substances were cracked into small molecules. Oxygen was completely removed. The sulfur content was less than 10 ppm. The final boiling point was reduced from 495° C. to 420° C. The content of heavy diesel was about 2%. It could be sold as a product. FIG. 4 shows the analysis results of the molecular weight distribution (GPC) of the dry biomass pyrolysis liquid, high-quality fuel oil, diesel and gasoline. It's indicated that the mixture obtained by hydrodeoxygenation and hydrocracking of the pyrolysis liquid included naphtha, gasoline, diesel and kerosene fractions, and the mixture was similar to gasoline and diesel. It was also found in this Example that, in order not to produce heavy diesel, the heavy diesel discharged from the bottom of the tower was mixed with the hydrogen donor and recycled back to the fluidized bed hydrodeoxygenation reactor, and underwent two-stage reactions of hydrodeoxygenation and hydrocracking. After a long-term operation, it was found that the amount of the products in this part of boiling range did not increase, indicating that this part of the substances could be hydroprocessed into low boiling point substances by the process and catalyst of the present disclosure.

### EXAMPLE 2

In this Example, two-stage hydrodeoxygenation reactors in series and two-stage hydrocracking reactors in series were used. The hydrogen donor was a high-quality fuel oil product having a boiling range of 180-240° C. obtained according to the present disclosure. In the first-stage hydrodeoxygenation reaction, the same catalyst Pd/C as used in Example 1 was used. In the second-stage hydrodeoxygenation reaction, NiMo/Al₂O₃ was used as the catalyst. The temperature of the first-stage hydrodeoxygenation reaction was controlled at 280° C., and the temperature of the second-stage hydrodeoxygenation reaction was controlled at 330° C. Different catalysts were used in the fixed bed reactions. The catalyst used in the first-stage refining cracking reaction was CoMo/Al₂O₃, the reaction temperature was controlled at 180° C., and the liquid hourly volume space velocity was 4.010. The catalyst in the second-stage hydrocracking reaction was NiW/Al₂O₃. The reactor size, catalyst loading, and liquid hourly volume space velocity for the second-stage hydrocracking reaction were the same as in Example 1, and the temperature was controlled at 350° C. The other operating conditions and the process flow were the same as in Example 1.

TABLE 8
Comparison of the properties of the deoxygenated oil produced in
Example 2 and Example 1 after the hydrodeoxygenation
reaction was run for 3000 h

| | Example 1 | Example 2 |
|---|---|---|
| Density, g/ml | 0.91 | 0.91 |
| Moisture, % | 0.0050 | 0.0050 |
| HHV, MJ/kg | 42.5 | 43.2 |
| TAN, mgKOH/g | 11 | 10 |

| | | | |
|---|---|---|---|
| Elemental | C | 81.1 | 81.6 |
| composition | H | 11.5 | 12.2 |
| wt % | O | 7.4 | 6.2 |
| | Others | <0.1 | <0.1 |
| Distillation | Initial boiling | 52 | 52 |
| range | point | | |
| ° C. | 5% | 105 | 103 |
| (ASTM | 20% | 137 | 135 |
| D1160) | 40% | 192 | 187 |
| | 60% | 235 | 233 |
| | 80% | 297 | 295 |
| | 95% | 381 | 374 |
| | 98% | 440 | 432 |
| | Final boiling | 495 | 485 |
| | point | | |

TABLE 9
Comparison of the properties of the high-quality fuel oil produced in
Example 2 and Example 1 after the hydrodeoxygenation
reaction was run for 3000 h

| | | Example 1 | Example 2 |
|---|---|---|---|
| Density, g/ml | | 0.82 | 0.82 |
| HHV, MJ/kg | | 46.2 | 46.4 |
| TAN, mgKOH/g | | 0.2 | 0.2 |
| Elemental | C | 87.9 | 87.8 |
| composition | H | 12.1 | 12.2 |
| wt % | O | <0.01 | <0.01 |
| | Others | <0.1, wherein | <0.1, wherein |
| | | S < 10 ppm | S < 10 ppm |
| Distillation | Initial | 55 | 55 |
| range | boiling | | |
| ° C. | point | | |
| (ASTM | 5% | 89 | 86 |
| D1160) | 20% | 135 | 132 |
| | 40% | 168 | 165 |
| | 60% | 217 | 208 |
| | 80% | 277 | 275 |
| | 95% | 341 | 332 |
| | 98% | 375 | 370 |
| | Final | 420 | 415 |
| | boiling | | |
| | point | | |

By comparing with the single-stage hydrodeoxygenation reaction and the single-stage hydrocracking reaction in Example 1, it was found that the two-stage fluidized bed hydrodeoxygenation plus fixed-bed hydrofining plus hydrocracking cascade reactions could provide substantially the same high-quality fuel oil yield as Example 1, because all reactions were carried out mainly for the purpose of hydrodeoxygenation, wherein components prone to polymerization were converted into stable components while oxygen was removed. At the same time, because the macromolecular substances in the biomass pyrolysis liquid were formed mainly with oxygen atoms as linkages, in the process of deoxygenation, these macromolecular substances became small molecular substances. In addition, the amount of fused ring aromatic hydrocarbons comprising three or more rings was extremely small in the biomass pyrolysis liquid. Thus, the final boiling point of the produced fuel was lower than 420° C., and the proportion of heavy diesel was less than 2%.

In the hydrodeoxygenation reactions of this Example, due to the two-stage reactions, the oxygen content in the deoxygenated oil was reduced from 7.4% to 6.2%, suggesting that the deoxygenation effect was improved significantly. Table 8 shows the specific data. It was also found in this Example that the use of the two-stage fixed-bed hydrofining and hydrocracking in series did not bring about significant change to the yield and product properties of the produced high-quality fuel oil (see Table 9 for the specific data), but the catalyst life could be prolonged. See Table 10 for details.

TABLE 10
Comparison of the influence of single-stage hydrocracking
reaction and two-stage hydrocracking reactions on catalyst life

| | Example 1 | Example 2 |
|---|---|---|
| Continuous running time, h | 6000 | 6000 |
| Increase of the pressure drop | 0.42 | 0.22 |
| of the reactor, MPa | | |
| Fuel oil yield, % | 85.65 | 85.68 |

In this Example, it was found that the main function of the first-stage fixed-bed hydrogenation reaction was to further hydroprocess, at a lower temperature, the unsaturated hydrocarbons left in the hydrodeoxygenated oil due to incomplete treatment and prone to polymerization, so as to obtain more stable substances. See Table 11 for the specific data. In the second-stage fixed-bed hydrocracking reaction, the polymerization reaction rate was reduced greatly. As a result, when the second-stage hydrocracking reaction in this Example and the hydrocracking reaction in Example 1 were carried out under exactly the same conditions, the pressure drop in the second-stage hydrocracking reactor increased at a lower rate, and thus the service life of the catalyst was extended greatly.

TABLE 11
Comparison of the GCMS analysis results of the deoxygenated oil in
Example 2 and the oil after the first-stage hydrocracking reaction

| | | Oil obtained after the |
|---|---|---|
| | | first-stage |
| | Deoxygenated oil | hydrocracking reaction |
| Alcohols | 2.48 | 2.49 |
| Lipids | 4.73 | 3.98 |
| Ketones | 1.15 | 0.52 |
| Aldehydes | 0.00 | 0.00 |
| Ethers | 2.05 | 1.23 |
| Carboxylic acids | 0.01 | 0.01 |
| Phenols | 15.15 | 15.08 |
| Alkanes | 47.65 | 49.55 |
| Aromatic | 25.28 | 26.95 |
| hydrocarbons | | |
| Unsaturated | 1.50 | 0.1 |
| hydrocarbons | | |

### Example 3

In this Example, a single-stage hydrodeoxygenation reactor was used. The biomass pyrolysis liquid was a liquid product obtained by rapid pyrolysis of wheat stalks. The hydrogen donor was light diesel. The catalyst used in the hydrodeoxygenation reaction was Ru/C (ruthenium supported on a carbon-based material). The other operating conditions were the same as in Example 1. Three-stage fixed-beds in series were used for the hydrocracking reaction. The catalysts used in the first-stage and second-stage hydrocracking reactions were the same as in Example 2, and the other operating conditions were the same as in Example 2. The operating temperature of the third-stage hydrocracking reaction was 380° C. The catalyst and other operating conditions used in the third-stage hydrocracking reaction were the same as in the second-stage hydrocracking reaction.

Table 12 shows a comparison of the properties of the high-quality fuel obtained in this Example with those obtained in Examples 1 and 2 after 2000 hours of continuous operation.

TABLE 12
Comparison of the properties of the high-quality fuel produced in
Example 3 with those in Examples 1 and 2

| | | Example 1 | Example 2 | Example 3 |
|---|---|---|---|---|
| Density, g/ml | | 0.82 | 0.82 | 0.82 |
| HHV, MJ/kg | | 46.2 | 46.4 | 46.4 |
| TAN, mgKOH/g | | 0.2 | 0.2 | 0.2 |
| Elemental | C | 87.9 | 87.8 | 87.8 |
| composition | H | 12.1 | 12.2 | 12.2 |
| wt % | O | <0.01 | <0.01 | <0.01 |
| | Others | <0.1, | <0.1, | <0.1, |
| | | wherein | Wherein | Wherein |
| | | S < 10 ppm | S < 10 ppm | S < 10 ppm |
| Distillation | Initial | 55 | 55 | 55 |
| range | boiling | | | |
| ° C. | point | | | |
| (ASTM | 5% | 89 | 86 | 86 |
| D1160) | 20% | 135 | 132 | 133 |
| | 40% | 168 | 165 | 165 |
| | 60% | 217 | 208 | 209 |
| | 80% | 277 | 275 | 276 |
| | 95% | 341 | 332 | 333 |
| | 98% | 375 | 370 | 369 |
| | Final | 420 | 415 | 414 |
| | boiling | | | |
| | point | | | |

It was found from the comparison that the high-quality fuel oil yield and fuel oil properties obtained using the single-stage hydrodeoxygenation reactor plus the three-stage fixed-bed hydrocracking reactors in series were substantially the same as those in Examples 1 and 2. This suggests that after the hydrodeoxygenation arrived at a certain level, the hydrocracking reaction had a large influence on the performances of the product. In addition, it was also found that the use of two-stage hydrocracking reactors in series could prolong the life of the hydrocracking catalyst, similar to Example 2.

### Example 4

In this Example, three-stage fluidized bed hydrodeoxygenation reactors in series were used. The biomass pyrolysis liquid was a liquid product obtained by slow hydrolysis of a mixture of poplar branches and bark. The hydrogen donor was a substance having a boiling range of 180-240° C. obtained by hydroprocessing coal tar. The catalyst used in the first-stage hydrodeoxygenation reaction was NiMn/C (nickel manganese supported on a carbon-based material). The catalyst used in the second-stage hydrodeoxygenation reaction was CoMo/Al₂O₃, the same as that used in the second-stage hydrodeoxygenation reaction in Example 2. The other operating conditions were the same as those in Example 2. The operating temperature of the third-stage hydrodeoxygenation reaction was 370° C., and the catalyst and other operating conditions used in the third-stage hydrodeoxygenation reaction were the same as those in the second-stage hydrocracking reaction. A single-stage fixed bed was used in the hydrocracking reaction, with the use of the same catalyst as in Example 1, namely NiW/Al₂O₃, while the other operating conditions were the same as those in the hydrocracking reaction in Example 1.

Table 13 shows a comparison of the properties of the deoxygenated oill obtained in this Example with those obtained in Example 1 after 2000 hours of continuous operation.

TABLE 13
Comparison of the properties of the deoxygenated oil produced in
Example 4 and Example 1 after the hydrodeoxygenation
reaction was run for 2000 h

| | | Example 1 | Example 4 |
|---|---|---|---|
| Dense, g/ml | | 0.91 | 0.91 |
| Moisture, % | | 0.0050 | 0.0050 |
| HHV, MJ/kg | | 42.5 | 43.0 |
| TAN, mgKOH/g | | 11 | 9 |
| Elemental | C | 81.1 | 81.2 |
| composition | H | 11.5 | 11.5 |
| wt % | O | 7.4 | 7.3 |
| | Others | <0.1 | <0.1 |
| Distillation | Initial boiling | 52 | 52 |
| range | point | | |
| ° C. | 5% | 105 | 105 |
| (ASTM | 20% | 137 | 136 |
| D1160) | 40% | 192 | 190 |
| | 60% | 235 | 234 |
| | 80% | 297 | 295 |
| | 95% | 381 | 378 |
| | 98% | 440 | 436 |
| | Final boiling | 495 | 488 |
| | point | | |

It was found from the analysis of the experimental results that, with the use of the staged treatment, the deoxygenation effect achieved with a non-noble metal catalyst was the same as that achieved with a noble metal catalyst, and the properties of the deoxygenated oil obtained were similar.

Table 14 shows a comparison of the high-quality fuel oil obtained by subjecting the deoxygenated oil obtained from the hydrodeoxygenation reaction to the hydrocracking reaction with the high-quality fuel oils obtained in Examples 1 and 2.

TABLE 14
Comparison of the properties of the high-quality fuel oil produced in
Example 4 with those in Examples 1 and 2

| | | Example 1 | Example 2 | Example 4 |
|---|---|---|---|---|
| Density, g/ml | | 0.82 | 0.82 | 0.82 |
| HHV, MJ/kg | | 46.2 | 46.4 | 46.3 |
| TAN, mgKOH/g | | 0.2 | 0.2 | 0.2 |
| Elemental | C | 87.9 | 87.8 | 87.9 |
| composition | H | 12.1 | 12.2 | 12.1 |
| wt % | O | <0.01 | <0.01 | <0.01 |
| | Others | <0.1, | <0.1, | <0.1, |
| | | wherein | wherein | wherein |
| | | S < 10 ppm | S < 10 ppm | S < 10 ppm |
| Distillation | Initial | 55 | 55 | 55 |
| range | boiling | | | |
| ° C. | point | | | |
| (ASTM | 5% | 89 | 86 | 87 |
| D1160) | 20% | 135 | 132 | 134 |
| | 40% | 168 | 165 | 167 |
| | 60% | 217 | 208 | 212 |
| | 80% | 277 | 275 | 276 |
| | 95% | 341 | 332 | 335 |
| | 98% | 375 | 370 | 372 |
| | Final | 420 | 415 | 417 |
| | boiling | | | |
| | point | | | |

It was found from the comparison that the high-quality fuel oil yield and fuel oil properties obtained in this Example were substantially similar to those in Examples 1 and 2. This suggests that after the deoxygenation effect of the hydrodeoxygenation reaction arrived at a certain level, the performances of the hydrocracked products were substantially the same.

This Example shows that when a non-precious metal catalyst and multi-stage fluidized bed reactors in series were used for hydrodeoxygenation, an ideal high-quality mixed fuel oil could also be obtained after the resulting deoxygenated oil was hydrocracked.

### Example 5

In this Example, a single-stage fluidized bed hydrodeoxygenation reactor was used. The biomass pyrolysis liquid was a liquid product obtained in the carbonization of corn stalks. The catalyst used was CoMo/C. The reaction temperature was 350° C. The mass ratios of the biomass pyrolysis liquid to the hydrogen donor were 1:2, 2:1, and 4:1 respectively, and other operating conditions were the same as in Example 1. Table 15 shows the properties of the deoxygenated oil obtained after 2000 hours of continuous operation.

TABLE 15
Comparison of the properties of the deoxygenated oil produced by the
hydrodeoxygenation reaction at different ratios of the biomass
pyrolysis liquid to the hydrogen donor

| Ratio of biomass pyrolysis | | | | |
|---|---|---|---|---|
| liquid to hydrogen donor | | 1:2 | 2:1 | 4:1 |
| Density, g/ml | | 0.87 | 0.91 | 0.94 |
| Viscosity | (@20° C.) | 0.95 | 1.2 | 4.3 |
| cp | (@60° C.) | 0.84 | 0.93 | 1.45 |
| HHV, MJ/kg | | 43.57 | 42.5 | 40.9 |
| TAN, mgKOH/g | | 8.5 | 11 | 22 |
| Elemental | C, % | 82.85 | 81.1 | 77.79 |
| composition | H, % | 13.73 | 11.5 | 11.36 |
| | O, % | 3.42 | 7.4 | 10.85 |
| | Others, % | <0.1 | <0.1 | <0.1 |
| Distillation | Initial boiling | 51 | 52 | 58 |
| range | point | | | |
| ° C. | 5% | 102 | 105 | 111 |
| (ASTM | 20% | 129 | 137 | 149 |
| D1160) | 40% | 185 | 192 | 201 |
| | 60% | 226 | 235 | 245 |
| | 80% | 285 | 297 | 301 |
| | 95% | 370 | 381 | 385 |
| | 98% | 428 | 440 | 455 |
| | Final boiling | 482 | 495 | 511 |
| | point | | | |

As it can be seen from the results, as the concentration of the biomass pyrolysis liquid in the hydrodeoxygenation reactor increased, the hydrodeoxygenation effect decreased, accompanied by an increased oxygen content in the resulting deoxygenated oil, a decreased heating value, an increased total acid value and an increased amount of the heavy components. Therefore, in addition to increasing the solubility of hydrogen, another purpose of adding the hydrogen donor in the present disclosure is to further reduce the concentration of the biomass pyrolysis liquid in the fluidized bed hydrodeoxygenation reactor, promote deoxygenation, slow down the polymerization reaction rate, and thus increase the catalyst life.

### Example 6

In this Example, a single-stage fluidized bed hydrodeoxygenation reactor was used. The catalyst used was NiCr/C. The temperatures of the hydrodeoxygenation reaction were 280° C., 310° C., 340° C. and 370° C. respectively. The other operating conditions were the same as those in Example 1. Table 16 shows the properties of the deoxygenated oil obtained after 1000 hours of continuous operation.

TABLE 16
Comparison of the properties of deoxygenated oil produced at
different hydrodeoxygenation reaction temperatures

| Reaction temperature, ° C. | | 280 | 310 | 340 | 370 |
|---|---|---|---|---|---|
| Density, g/ml | | 0.96 | 0.93 | 0.91 | 0.93 |
| Viscosity, cp (@20° C.) | | 15.4 | 4.3 | 1.2 | 16.5 |
| HHV, MJ/kg | | 41.0 | 41.3 | 42.5 | 42.1 |
| TAN, mgKOH/g | | 34 | 25 | 11 | 33 |
| Elemental | C, % | 78.2 | 79.1 | 81.1 | 81.1 |
| composition | H, % | 11.6 | 11.5 | 11.4 | 11.4 |
| | O, % | 10.2 | 9.4 | 7.4 | 7.5 |
| | Others, % | <0.1 | <0.1 | <0.1 | <0.1 |

As it can be seen from the comparison of the results, as the reaction temperature increased, the hydrodeoxygenation effect was improved, accompanied by a decreased oxygen content in the resulting deoxygenated oil, and an increased heating value. However, when the reaction temperature exceeded 340° C., the oxygen content in the deoxygenated oil did not decrease significantly, the heating value decreased, while the total acid value and the viscosity increased instead. The reason is that, when the temperature is too high, the hydrodeoxygenation reaction is limited by the mass transfer rate and cannot be further accelerated, but the high temperature accelerates the polymerization reaction, such that a portion of the unreacted substances undergo polymerization.

### Example 7

In this Example, a single-stage fluidized bed hydrodeoxygenation reactor was used. The catalyst used was CoNb/Al₂O₃. The temperature of the hydrodeoxygenation reaction was 330° C. The reaction pressures were 11.0 MPa, 13.0 Pa, 15.0 MPa and 18.0 MPa, respectively. The other operating conditions were the same as those in Example 1. Table 17 shows the properties of the deoxygenated oil obtained after 1000 hours of continuous operation.

TABLE 17
Comparison of the properties of the deoxygenated oil produced at
different hydrodeoxygenation reaction pressures

| Reaction pressure, MPa | | 11.0 | 13.0 | 15.0 | 18.0 |
|---|---|---|---|---|---|
| Density, g/ml | | 0.96 | 0.93 | 0.91 | 0.90 |
| Viscosity, cp (@20° C.) | | 16.4 | 6.3 | 1.2 | 1.1 |
| HHV, MJ/kg | | 40.3 | 41.4 | 42.5 | 42.9 |
| TAN, mgKOH/g | | 43 | 24 | 11 | 9.3 |
| Elemental | C, % | 78.4 | 79.6 | 81.1 | 81.2 |
| composition | H, % | 10.6 | 10.8 | 11.4 | 11.5 |
| | O, % | 10.9 | 9.5 | 7.4 | 7.2 |
| | Others, % | <0.1 | <0.1 | <0.1 | <0.1 |

As it can be seen from the comparison of the results, as the reaction pressure increased, the hydrodeoxygenation effect was improved, accompanied by a decreased oxygen content in the resulting deoxygenated oil, an increased heating value, a decreased total acid value, and a decreased viscosity. The reason is that, as the pressure increases, the partial pressure of hydrogen in the reaction system increases, which is conducive to the deoxygenation reaction, but the increased pressure will increase the investment and operating costs of the equipment.

### Example 8

In this Example, a single-stage fluidized bed hydrodeoxygenation reactor was used. The catalyst used was NiCeZr/Al₂O₃. The reaction temperature was 330° C. The mass ratios of the circulating oil to the biomass pyrolysis liquid (abbreviated as circulation ratio) in the hydrodeoxygenation reaction were 2:1, 3:1, 4:1, 5:1, and 6:1 respectively. The other operating conditions were the same as in Example 1. Table 18 shows the properties of the deoxygenated oil obtained after 1000 hours of continuous operation.

TABLE 18
Comparison of the properties of the deoxygenated oil
produced by the hydrodeoxygenation reaction at different
circulation ratios

| Circulation ratio | | 2:1 | 3:1 | 4:1 | 5:1 | 6:1 |
|---|---|---|---|---|---|---|
| Density, g/ml | | 0.931 | 0.921 | 0.913 | 0.911 | 0.906 |
| Viscosity, cp (@20° C.) | | 9.7 | 4.3 | 1.2 | 1.0 | 1.0 |
| HHV, MJ/kg | | 41.2 | 41.8 | 42.5 | 42.9 | 43.1 |
| TAN, mgKOH/g | | 24 | 19 | 11 | 10 | 9.5 |
| Elemental | C, % | 78.4 | 80.6 | 81.1 | 81.2 | 81.3 |
| composition | H, % | 10.6 | 11.2 | 11.4 | 11.4 | 11.4 |
| | O, % | 10.9 | 8.2 | 7.4 | 7.3 | 7.2 |
| | Others, % | <0.1 | <0.1 | <0.1 | <0.1 | <0.1 |

As it can be seen from the experimental results, the variation of the circulation ratio of the hydrodeoxygenation reaction has a significant influence on the deoxygenation effect. The main purposes of using the circulating oil include: 1. diluting the biomass pyrolysis liquid to slow down the polymerization rate; 2. driving the catalyst in the reactor to a fluidized state, and co-working with the biomass pyrolysis liquid, the circulating oil, the hydrogen donor, hydrogen, the catalyst and the internal component to form a completely mixed flow catalyst circulation system. If the circulation ratio is too low, the fluidization effect on the catalyst is unsatisfactory, and the circulation ratio may even exceed the operating range of the fluidized bed reactor. In addition, the dilution effect on the raw materials is also greatly degraded, which will lead to insignificant deoxygenation at the end. If the circulation ratio is increased to the operating range of the fluidized bed reactor, an ideal deoxidation effect can be achieved. Further increase in the circulation ratio has little effect on the properties of the resulting deoxygenated oil. If the circulation ratio is too high and exceeds the operating range of the fluidized bed reactor, damage to downstream process equipment will occur. Therefore, it is very important to select an appropriate circulation ratio according to the internal component in the reactor and the characteristics of the catalyst. The preferred circulation ratio in the present disclosure is in the range of 2:1 to 7:1.

### Example 9

In this Example, a single-stage fluidized bed hydrodeoxygenation reactor was used. The catalyst was NiRu/C. The reaction temperature was 330° C. The standard state volume ratios of hydrogen to the biomass pyrolysis liquid in the hydrodeoxygenation reaction were 300:1, 500:1, 700:1, 900:1, and 1100:1 respectively. The other operating conditions were the same as in Example 1. Table 19 shows the properties of the deoxygenated oil obtained after 1000 hours of continuous operation.

TABLE 19
Comparison of the properties of the deoxygenated oil produced at
different hydrogen-to-oil ratios in the hydrodeoxygenation reaction

| Hydrogen-to-oil ratio, | | 300:1 | 500:1 | 700:1 | 900:1 | 1100:1 |
|---|---|---|---|---|---|---|
| v/v | | | | | | |
| Density, g/ml | | 0.931 | 0.917 | 0.911 | 0.910 | 0.909 |
| Viscosity, cp (@20° C.) | | 12.3 | 1.8 | 1.2 | 1.0 | 1.0 |
| HHV, MJ/kg | | 40.5 | 41.6 | 42.5 | 42.8 | 42.8 |
| TAN, mgKOH/g | | 32 | 18 | 11 | 10 | 9.5 |
| Elemental | C, % | 78.1 | 80.6 | 81.1 | 81.3 | 81.3 |
| composition | H, % | 10.6 | 11.1 | 11.4 | 11.4 | 11.4 |
| | O, % | 11.3 | 8.3 | 7.4 | 7.2 | 7.2 |
| | Others, % | <0.1 | <0.1 | <0.1 | <0.1 | <0.1 |

As it can be seen from the comparison of the deoxygenated oil properties, as the hydrogen-to-oil ratio increased, the hydrodeoxygenation effect was improved, accompanied by a decreased oxygen content in the resulting deoxygenated oil, an increased heating value, a decreased total acid value, and a decreased viscosity. Nonetheless, when the hydrogen-to-oil ratio reached a certain value, the decrease of the oxygen content in the deoxygenated oil, the increase of the heating value, the decrease of the total acid value, and the decrease of the viscosity were not conspicuous. The reason is that, when the hydrogen-to-oil ratio is relatively small, the partial pressure of hydrogen in the reactor is small, and thus the hydrodeoxygenation reaction is incomplete. When the partial pressure of hydrogen reaches a certain level, as the deoxygenation reaction is limited by the mass transfer rate, temperature and other factors, further increase of the hydrogen-to-oil ratio has little effect on the deoxygenation reaction, while a high hydrogen-to-oil ratio will increase the operating cost.

### Example 10

In this Example, a single-stage fluidized bed hydrodeoxygenation reactor was used. The catalyst was Ni/C. The reaction temperature was 330° C. The liquid hourly volume space velocities of the hydrodeoxygenation reaction were 0.4 h⁻¹, 0.6 h⁻¹, 0.8 h⁻¹, 1.0 h⁻¹ and 1.4 h⁻¹. The other operating conditions were the same as in Example 1. Table 20 shows the properties of the deoxygenated oil obtained after 1000 hours of continuous operation.

TABLE 20
Comparison of the properties of the deoxygenated oil produced
at different liquid hourly volume space velocities in the
hydrodeoxygenation reaction

| Liquid hourly volume | | 0.4 | 0.6 | 0.8 | 1.0 | 1.4 |
|---|---|---|---|---|---|---|
| space velocity, h⁻¹ | | | | | | |
| Density, g/ml | | 0.902 | 0.911 | 0.928 | 0.942 | 0.948 |
| Viscosity, cp (@20° C.) | | 1.1 | 1.2 | 4.6 | 7.8 | 9.8 |
| HHV, MJ/kg | | 42.9 | 42.5 | 41.7 | 41.4 | 41.1 |
| TAN, mgKOH/g | | 8 | 11 | 21 | 30 | 35 |
| Elemental | C, % | 81.3 | 81.1 | 80.5 | 79.2 | 78.3 |
| composition | H, % | 11.6 | 11.4 | 11.2 | 10.8 | 10.5 |
| | O, % | 7.0 | 7.4 | 8.3 | 10.0 | 11.2 |
| | Others, % | <0.1 | <0.1 | <0.1 | <0.1 | <0.1 |

As it can be seen from the comparison of the deoxygenated oil properties, in respect of the hydrodeoxygenation effect, as the liquid hourly volume space velocity increased, the oxygen content in the resulting deoxygenated oil increased, the heating value decreased, and the total acid value and viscosity increased. The reason is that, when the liquid hourly volume space velocity increases, some substances that have no time to react will undergo polymerization at high temperatures.

### Example 11

In this Example, a single-stage fluidized bed hydrodeoxygenation reactor was used. The catalyst was NiCr/C. The reaction temperature was 330° C. The other operating conditions were the same as in Example 1. After 3000 hours of continuous operation, the activity of the catalyst was found to decrease. After the catalyst was subjected to swirl washing with butanol and reduced, the regenerated catalyst and the primary fresh catalyst were put into the fluidized bed hydrodeoxygenation reactor in a certain ratio. Table 21 compares the properties of the deoxygenated oil produced after 1000 hours of operation with those of the deoxygenated oil produced with no addition of the regenerated catalyst.

TABLE 21
Comparison of the properties of the deoxygenated oil produced
in the hydrodeoxygenation reaction before and after adding the
regenerated catalyst

| Continuous operating time, h | | 1000 | 1000 | | | | |
|---|---|---|---|---|---|---|---|
| Weight ratio of regenerated | | 0 | 1:4 | 1:2 | 1:1 | 2:1 | 4:1 |
| catalyst to fresh catalyst | | | | | | | |
| Density, g/ml | | 0.906 | 0.907 | 0.907 | 0.907 | 0.907 | 0.907 |
| Viscosity, cp (@20° C.) | | 1.1 | 1.1 | 1.2 | 1.3 | 1.4 | 1.5 |
| HHV, MJ/kg | | 42.7 | 42.8 | 42.7 | 42.7 | 42.7 | 42.6 |
| TAN, mgKOH/g | | 10 | 9 | 10 | 10 | 10 | 11 |
| Elemental | C, % | 81.2 | 81.2 | 81.2 | 81.2 | 81.2 | 81.1 |
| composition | H, % | 11.5 | 11.6 | 11.5 | 11.5 | 11.5 | 11.5 |
| | O, % | 7.2 | 7.1 | 7.2 | 7.2 | 7.2 | 7.3 |
| | Others, % | <0.1 | <0.1 | <0.1 | <0.1 | <0.1 | <0.1 |

As a comparison between the experimental results after regeneration of the catalyst with reduced activity and the experimental results without adding the regenerated catalyst, when the experiment without adding the regenerated catalyst ran for 1000 hours, the hydrodeoxygenation reaction reduced the mass content of oxygen in the biomass pyrolysis liquid from 49.4% to 7.2%; when the experiment with the addition of 80% regenerated catalyst ran for 1000 hours, the hydrodeoxygenation reaction reduced the mass content of oxygen in the biomass pyrolysis liquid from 49.4% to 7.3%. The comparison shows that the deoxygenation rate hardly changes, indicating that the catalyst regeneration method of the present disclosure can restore the catalyst activity by more than 99%.

### Example 10

In this Example, a single-stage fixed-bed hydrocracking reactor was used. The catalyst was CoMo/Al₂O₃. The temperatures of the hydrocracking reaction were 300° C., 330° C., 360° C. and 390° C., respectively. The other operating conditions were the same as those for the hydrocracking reaction in Example 1. The deoxygenated oil obtained in Example 1 was used as the raw material. Table 22 shows the properties of the fuel oil produced after 1000 hours of continuous operation.

TABLE 22
Comparison of the properties of the fuel oil produced at different
hydrocracking reaction temperatures

| Reaction temperature, ° C. | | 300 | 330 | 360 | 390 |
|---|---|---|---|---|---|
| Density, g/ml | | 0.829 | 0.826 | 0.821 | 0.816 |
| HHV, MJ/kg | | 45.9 | 46.0 | 46.2 | 46.2 |
| TAN, mg KOH/g | | 0.2 | 0.2 | 0.2 | 0.1 |
| Distillation | Initial boiling | 56 | 55 | 53 | 51 |
| range | point | | | | |
| ° C. | 5% | 92 | 89 | 88 | 83 |
| (ASTM | 20% | 137 | 135 | 134 | 130 |
| D1160) | 40% | 172 | 168 | 165 | 161 |
| | 60% | 222 | 217 | 215 | 211 |
| | 80% | 283 | 277 | 274 | 269 |
| | 95% | 345 | 341 | 340 | 337 |
| | 98% | 381 | 375 | 373 | 370 |
| | Final boiling | 426 | 420 | 418 | 415 |
| | point | | | | |

As it can be seen from the experimental results, as the temperature increased, the density of the fuel oil obtained decreased, the heating value increased, and the final boiling point decreased. The reason is that, as the temperature increases, the hydrocracking reaction rate increases. However, if the temperature is too high, the proportion of light hydrocarbon components obtained increases, and the yield of the fuel oil decreases.

### Example 13

In this Example, a single-stage fixed-bed hydrocracking reactor was used. The catalyst was NiW/Al₂O₃. The pressures of the hydrocracking reaction were 12.0 MPa, 13.5 MPa, 15.0 MPa and 18.0 MPa, respectively. The other operating conditions were the same as those for the hydrocracking reaction in Example 1. The deoxygenated oil obtained in Example 1 was used as the raw material. Table 23 shows the properties of the fuel oil produced after 1000 hours of continuous operation.

TABLE 23
Comparison of the properties of the fuel oil produced at different
hydrocracking reaction pressures

| Reaction pressure, MPa | | 12.0 | 13.5 | 15.0 | 18.0 |
|---|---|---|---|---|---|
| Density, g/ml | | 0.825 | 0.823 | 0.821 | 0.820 |
| HHV, MJ/kg | | 46.0 | 46.1 | 46.2 | 46.2 |
| TAN, mgKOH/g | | 0.2 | 0.2 | 0.2 | 0.1 |
| Distillation | Initial boiling | 56 | 55 | 55 | 54 |
| range | point | | | | |
| ° C. | 5% | 92 | 90 | 89 | 88 |
| (ASTM | 20% | 137 | 136 | 135 | 134 |
| D1160) | 40% | 170 | 169 | 168 | 166 |
| | 60% | 220 | 218 | 217 | 216 |
| | 80% | 282 | 278 | 277 | 275 |
| | 95% | 345 | 342 | 341 | 338 |
| | 98% | 380 | 376 | 375 | 373 |
| | Final boiling | 426 | 421 | 420 | 418 |
| | point | | | | |

As it can be seen from the experimental results, as the reaction pressure increased, the density of the fuel oil obtained decreased, the heating value increased, and the final boiling point decreased. The reason is that, as the pressure increases, the hydrocracking reaction rate increases. However, if the pressure is too high, the proportion of light hydrocarbon components obtained increases, and the yield of the fuel oil decreases.

### Example 14

In this Example, a two-stage fixed-bed hydrocracking reactor was used. The catalyst used was the same as that used in the hydrocracking reaction in Example 2. The standard state volume ratios of hydrogen to deoxygenated oil in the hydrocracking reaction were 300:1, 500:1, 700:1, 900:1 and 1100:1, respectively. The other operating conditions were the same as those for the hydrocracking reaction in Example 2. The deoxygenated oil obtained in Example 2 was used as the raw material. Table 24 shows the properties of the fuel oil produced after 1000 hours of continuous operation.

TABLE 24
Comparison of the properties of the fuel oil produced by the
hydrocracking reaction at different hydrogen-to-oil volume ratios

| Hydrogen-to-oil ratio | | 300:1 | 500:1 | 700:1 | 900:1 | 1100:1 |
|---|---|---|---|---|---|---|
| Density, g/ml | | 0.829 | 0.826 | 0.821 | 0.816 | 0.815 |
| HHV, MJ/kg | | 45.9 | 46.0 | 46.2 | 46.2 | 46.5 |
| TAN, mgKOH/g | | 0.2 | 0.2 | 0.2 | 0.1 | 0.1 |
| Distillation | Initial boiling | 56 | 55 | 53 | 52 | 50 |
| range ° C. | point | | | | | |
| | 5% | 95 | 90 | 88 | 87 | 85 |
| | 20% | 142 | 137 | 134 | 133 | 132 |
| | 40% | 176 | 170 | 165 | 163 | 161 |
| | 60% | 228 | 221 | 215 | 213 | 211 |
| | 80% | 289 | 277 | 274 | 271 | 269 |
| | 95% | 353 | 344 | 340 | 337 | 335 |
| | 98% | 390 | 379 | 373 | 370 | 367 |
| | Final boiling | 435 | 423 | 418 | 417 | 415 |
| | point | | | | | |

As it can be seen from the experimental results, as the hydrogen-to-oil ratio increased, the density of the fuel oil obtained from the reaction decreased, the heating value increased, and the final boiling point decreased. The reason is that, as the hydrogen-to-oil ratio increases, the partial pressure of hydrogen increases, and thus the hydrocracking reaction rate increases. As a result, the proportion of light hydrocarbon components obtained increases, and the yield of the fuel oil decreases slightly.

### Example 15

In this Example, a single-stage fixed-bed hydrocracking reactor was used. The catalyst used was the same as that used in the hydrocracking reaction in Example 1. The liquid hourly volume space velocities in the hydrocracking reaction were 1.0 h⁻¹, 1.5 h⁻¹, 2.0 h⁻¹, 3.0 h⁻¹ and 4.0 h⁻¹, respectively. The other operating conditions were the same as those in Example 1. The deoxygenated oil obtained in Example 1 was used as the raw material. Table 25 shows the properties of the fuel oil produced after 1000 hours of continuous operation.

TABLE 25
Comparison of the properties of the fuel oil produced at different liquid
hourly volume space velocities in the hydrocracking reaction

| Liquid hourly | | 1.0 | 1.5 | 2.0 | 3.0 | 4.0 |
|---|---|---|---|---|---|---|
| volume space | | | | | | |
| velocity, h⁻¹ | | | | | | |
| Density, g/ml | | 0.817 | 0.820 | 0.821 | 0.831 | 0.842 |
| HHV, MJ/kg | | 46.5 | 46.3 | 46.2 | 45.8 | 45.4 |
| TAN, mgKOH/g | | 0.1 | 0.2 | 0.2 | 0.3 | 0.4 |
| Distillation | Initial | 54 | 55 | 55 | 55 | 56 |
| range ° C. | boiling | | | | | |
| | point | | | | | |
| | 5% | 86 | 87 | 89 | 92 | 95 |
| | 20% | 132 | 134 | 135 | 138 | 142 |
| | 40% | 164 | 166 | 168 | 171 | 175 |
| | 60% | 212 | 215 | 217 | 220 | 225 |
| | 80% | 271 | 274 | 277 | 281 | 286 |
| | 95% | 337 | 339 | 341 | 345 | 350 |
| | 98% | 369 | 372 | 375 | 378 | 384 |
| | Final | 413 | 417 | 420 | 424 | 432 |
| | boiling | | | | | |
| | point | | | | | |

As it can be seen from the experimental results, as the liquid hourly volume space velocity increased in the reaction, the density of the fuel oil obtained from the reaction increased, the heating value decreased, and the final boiling point increased.

### Example 16

In this Example, a single-stage fixed-bed hydrocracking reactor was used. The catalyst used was the same as that used in the hydrocracking reaction in Example 1. The mass contents of free water in the raw materials of the hydrocracking reaction were 10 ppm, 100 ppm, 0.1%, 0.5%, and 1%, respectively. The other operating conditions were the same as those in Example 1. Table 26 shows the properties of the high-quality fuel oil produced after 1000 hours of continuous operation.

TABLE 26
Comparison of the properties of the high-quality fuel oil
produced by the hydrocracking reaction at different free
water contents

| Mass content of | | 10 ppm | 100 ppm | 0.1% | 0.5% | 1.0% |
|---|---|---|---|---|---|---|
| free water | | | | | | |
| Density, g/ml | | 0.815 | 0.827 | 0.835 | 0.842 | 0.851 |
| HHV, MJ/kg | | 46.5 | 46.1 | 45.8 | 45.4 | 44.8 |
| TAN, mgKOH/g | | 0.1 | 0.2 | 0.5 | 2.1 | 3.5 |
| Distillation | Initial | 55 | 55 | 55 | 55 | 55 |
| range ° C. | boiling | | | | | |
| | point | | | | | |
| | 5% | 87 | 88 | 89 | 89 | 92 |
| | 20% | 131 | 135 | 136 | 138 | 140 |
| | 40% | 163 | 167 | 168 | 170 | 172 |
| | 60% | 211 | 213 | 215 | 220 | 223 |
| | 80% | 270 | 274 | 278 | 281 | 285 |
| | 95% | 336 | 338 | 346 | 348 | 352 |
| | 98% | 368 | 374 | 378 | 382 | 388 |
| | Final | 410 | 419 | 421 | 428 | 438 |
| | boiling | | | | | |
| | point | | | | | |

As it can be seen from the comparison of the properties of the deoxygenated oil, in respect of the hydrodeoxygenation effect, as the mass content of free water increased, the total acid value of the product obtained increased, and the heating value decreased. The reason is that, when the hydrocracking catalyst is rich in free water, its support skeleton is prone to collapse. In addition, when a sulfide catalyst is used, free water will also accelerate deactivation of the catalyst. Therefore, an increased free water content in the raw materials for the hydrocracking reaction will accelerate deactivation of the catalyst and affect long-term operation of the reaction. However, a decreased mass content of free water imposes a higher requirement on the dehydration efficiency of the deoxygenated oil, which will increase the investment cost and operating cost. In view of the characteristics of the catalyst in the present disclosure, the free water content in the raw materials for the hydrocracking reaction in the present disclosure is preferably 10-1000 ppm.

### Example 17

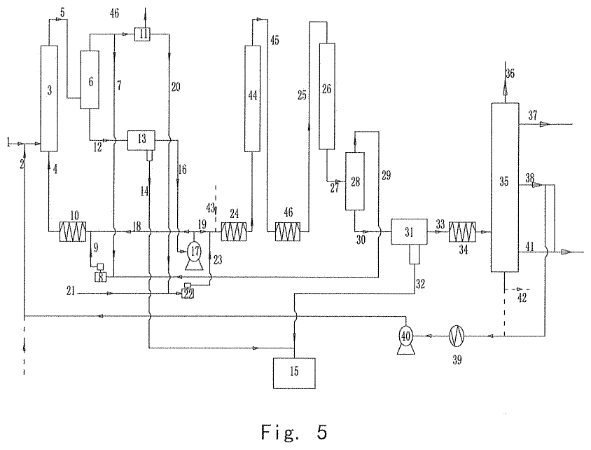

FIG. 5 shows a schematic view of the process flow of this Example.

In this Example, two-stage fixed-bed hydrocracking reactors in series were used, and the catalyst used was the same as that used in the hydrocracking reaction in Example 2. After the deoxygenated oil 19 and heavy diesel, wax oil or coal tar 43 were heated in the heating furnace 24, they entered the first-stage fixed-bed hydrofining reactor 44 for reaction, and the reaction product 45 was heated in the heating furnace 46 and then entered the fixed-bed hydrocracking reactor 26 for co-refining. The other operating conditions were the same as those for the hydrocracking reaction in Example 2. Table 27 shows the properties of the high-quality fuel oil produced after 3000 hours of continuous operation.

TABLE 27
Comparison of the properties of the high-quality fuel oil obtained by
co-refining the deoxygenated oil with heavy diesel, wax oil or coal tar

| Type of purchased oil | | Heavy | Heavy | Heavy | Wax | Low- |
|---|---|---|---|---|---|---|
| | | diesel | diesel | diesel | oil | temperature |
| | | | | | | coal tar |
| Weight percentage of | | 0 | 30 | 60 | 30 | 30 |
| purchased oil over the | | | | | | |
| total amounts of | | | | | | |
| deoxygenated oil and | | | | | | |
| purchased oil, wt % | | | | | | |
| Density, g/ml | | 0.816 | 0.817 | 0.822 | 0.818 | 0.819 |
| HHV, MJ/kg | | 46.4 | 46.3 | 46.2 | 46.3 | 46.2 |
| TAN, mgKOH/g | | 0.1 | 0.2 | 0.3 | 0.2 | 0.3 |
| Sulfur content, ppm | | 5 | 6 | 8 | 6 | 8 |
| Distillation | Initial | 55 | 55 | 55 | 55 | 55 |
| range ° C. | boiling | | | | | |
| | point | | | | | |
| | 5% | 86 | 87 | 90 | 87 | 89 |
| | 20% | 132 | 134 | 136 | 135 | 136 |
| | 40% | 165 | 168 | 172 | 169 | 171 |
| | 60% | 208 | 214 | 222 | 215 | 223 |
| | 80% | 275 | 278 | 282 | 278 | 280 |
| | 95% | 332 | 342 | 347 | 340 | 347 |
| | 98% | 370 | 374 | 380 | 374 | 380 |
| | Final | 415 | 454 | 463 | 457 | 461 |
| | boiling | | | | | |
| | point | | | | | |

Note:
The low-temperature coal tar in this Example was a liquid substance obtained by low-temperature cracking of candle bituminous coal (<500° C.).

As it can be seen from the results, the high-quality fuel oil obtained by co-refining deoxygenated oil with heavy diesel, wax oil or coal tar can also meet the relevant standards of vehicle fuel. Since the deoxygenated oil produced according to the present disclosure can be completely miscible with heavy diesel, wax oil or coal tar in any ratio, the requirements of the raw materials for the hydrocracking reaction in the present disclosure can be met. In addition, the fixed bed catalyst used is similar to the traditional catalyst used for hydroprocessing heavy diesel, wax oil or coal tar. The implementation results show that the present disclosure can achieve co-refining of deoxygenated oil with heavy diesel, wax oil or coal tar, and can make use of traditional refining equipment to achieve co-refining, thereby saving equipment investment, and greatly increasing the capacity of the equipment for producing final products, so that the economy of the present disclosure is further increased.

1. A method for preparing a high-quality fuel oil and/or chemical raw material from a biomass pyrolysis liquid, comprising the following steps:
A) subjecting the biomass pyrolysis liquid to hydrodeoxygenation reaction in a completely mixed flow catalyst circulation system in a fluidized bed reactor to obtain a deoxygenated oil; and
B) subjecting the deoxygenated oil from step A) to hydrocracking reaction in a fixed bed reactor to obtain a high-quality fuel oil and/or chemical raw material.

2. The method of claim 1, wherein the biomass pyrolysis liquid is mixed with a hydrogen donor before entering the fluidized bed reactor, and then enters the reactor at room temperature to 80° C. under the protection of the hydrogen donor.

3. The method of claim 2, wherein the deoxygenated oil from step A) is divided into two portions, wherein one portion of the deoxygenated oil, used as a circulating oil, is mixed with hydrogen and then returns to the fluidized bed reactor from a bottom of the reactor, and the other portion of the deoxygenated oil is mixed with hydrogen, and then enters the fixed bed reactor for hydrocracking reaction.

4. The method of claim 3, wherein the other portion of the deoxygenated oil is blended with at least one of heavy diesel, wax oil and coal tar before entering the fixed bed reactor for hydrocracking reaction.

5. The method of claim 3, wherein the hydrodeoxygenation reaction employs a temperature of 200° C.-400° C., a pressure of 10-20 MPa, a reaction volume space velocity of 0.6-2.0 h⁻¹, a hydrogen-to-oil ratio of 400:1-1000:1, a circulation ratio of 1: 4-4:1, and a mass ratio of the hydrogen donor to the biomass pyrolysis liquid of 0.2:1-4:1; and the hydrocracking reaction employs a temperature of 150° C.-420° C., a pressure of 12-20 MPa, a reaction volume space velocity of 1.0-4.0 h⁻¹, and a hydrogen-to-oil ratio of 400:1-1200:1.

6. The method of claim 2, wherein the biomass hydrolysis liquid enters the reactor at room temperature to 50° C.

7. The method of claim 2, wherein the hydrogen donor is at least one of hydrocarbon substances obtained by hydrocracking, petroleum hydrocarbon substances, hydrocarbon substances obtained by hydroprocessing coal tar, and hydrocarbon substances obtained by hydrodeoxygenation of organics, wherein the hydrocarbon substances have a boiling point in the range of 160-260° C.

8. The method of claim 4, wherein the hydrodeoxygenation reaction employs a temperature of 200° C.-400° C., a pressure of 10-20 MPa, a reaction volume space velocity of 0.6-2.0 h⁻¹, a hydrogen-to-oil ratio of 400:1-1000:1, a circulation ratio of 1: 4-4:1, and a mass ratio of the hydrogen donor to the biomass pyrolysis liquid of 0.2:1-4:1; and the hydrocracking reaction employs a temperature of 150° C.-420° C., a pressure of 12-20 MPa, a reaction volume space velocity of 1.0-4.0 h⁻¹, and a hydrogen-to-oil ratio of 400:1-1200:1.

9. The method of claim 1, wherein the completely mixed flow catalyst circulation means that the macroscopic movement of catalyst particles is manifested as a movement in the form of fluidization from a bottom of the reactor to a material level in the reactor, and then back to the bottom of the reactor.

10. The method of claim 1, wherein the completely mixed flow catalyst circulation system is formed under a combined action of the biomass pyrolysis liquid, a hydrogen donor, a circulating oil, hydrogen, a catalyst, a hydrodeoxygenation product and an internal component.

11. The method of claim 1, wherein the completely mixed flow catalyst circulation system is formed under a combined action of the following three factors: a fluidization kinetic energy provided by the circulating oil and hydrogen drives the catalyst into a fluidized state; a high-speed disturbance of the fluidized catalyst and a mixture of the circulating oil and hydrogen promotes rapid mixing and dilution of the biomass pyrolysis liquid and the hydrogen donor; and the internal component of the fluidized bed reactor acts to direct, split and swirl a gas-liquid-solid three-phase mixture.

12. The method of claim 1, wherein a catalyst from the completely mixed flow catalyst circulation system is a spherical catalyst.

13. The method of claim 1, wherein the biomass pyrolysis liquid includes a liquid substance derived from various biomass species by slow pyrolysis, fast pyrolysis, flash pyrolysis, carbonization or gasification processes.

14. The method of claim 1, wherein the catalyst is a Group VIII metal alone or a Group VIII metal with one or two of Group IVB, Group VB, Group VIB, Group VIIB, Group IB, and Group IIB metals added as an active component supported on activated carbon or porous carbon, or a catalyst formed from a metal oxide with a carbonized surface.

15. The method of claim 1, wherein after the catalyst is discharged from the bottom of the fluidized bed reactor, it is regenerated by washing with an alcohol, hydrocarbon or tetrahydrofuran solvent to restore activity.

16. The method of claim 1, wherein the fluidized bed reactor adopts a single-stage form, or a form of two stages or multiple stages in series; wherein the fixed-bed reactor adopts a single-stage form, or a form of two stages or multiple stages in series.
